(19) United States
(12) Patent Application Publication
(10) Pub. No.: US 2022/0083636 A1
(43) Pub. Date: Mar. 17, 2022

(54) SMART TIMEOUT WITH CHANGE DETECTION

(71) Applicant: QUALCOMM Incorporated, San Diego, CA (US)

(72) Inventors: Michel Adib SARKIS, San Diego, CA (US); Wesley James HOLLAND, Encinitas, CA (US); Venkata Ravi Kiran DAYANA, San Diego, CA (US); Ning BI, San Diego, CA (US)

(21) Appl. No.: 17/024,498

(22) Filed: Sep. 17, 2020

(51) Int. Cl. G06F 21/32; G06K 9/00; G06K 9/62; G06N 3/08

(52) U.S. Cl. CPC G06F 21/32; G06K 9/00268; G06K 9/00288; G06F 2221/2137; G06K 9/00228; G06K 9/6217; G06N 3/08; G06K 9/6202

(57) ABSTRACT

Techniques and systems are provided for processing one or more images. For example, a process can obtain a plurality of images captured during a session. The plurality of images include a current image of a current face. The process can extract features of the current face from the current image. The process can compare the extracted features of the current face to extracted features of a previous face from a previous image of the plurality of images captured during the session. The process can determine, based on comparing the extracted features of the current face to the extracted features of the previous face, whether the current face from the current image matches the previous face from the previous image. The process can determine whether to lock access to a computing device based on whether the current face from the current image matches the previous face from the previous image.

### FIELD

The present disclosure generally relates to object authentication, and more specifically to techniques and systems providing smart timeout with change detection (e.g., face change detection).

### BACKGROUND

Object authentication and/or verification can be used to authenticate or verify an object. For example, biometric-based authentication methods exist for authenticating people. Biometric-based authentication can be used for various purposes, such as providing access to places and/or electronic devices. Examples of biometric-based authentication include face authentication, fingerprint authentication, voice authentication, among others.

Face authentication, for example, can compare a face of a device user in an input image with known features of the person the user claims to be, in order to authenticate that the user of the device is, in fact, the person. A similar process can be performed for fingerprint authentication, voice authentication, and other biometric-based authentication methods.

### SUMMARY

Systems and techniques are described herein that provide a smart timeout mechanism with change detection, such as face change detection. In one illustrative example, a method of processing one or more images is provided. The method includes: obtaining a plurality of images captured during a session, the plurality of images including a current image of a current face; extracting features of the current face from the current image; comparing the extracted features of the current face to extracted features of a previous face from a previous image of the plurality of images captured during the session, the previous image being obtained prior to the current image; determining, based on comparing the extracted features of the current face to the extracted features of the previous face, whether the current face from the current image matches the previous face from the previous image; and determining whether to lock access to a computing device based on whether the current face from the current image matches the previous face from the previous image.

In another example, an apparatus for processing one or more images is provided that includes a memory configured to store one or more images and a processor (e.g., implemented in circuitry) coupled to the memory. The processor is configured to: obtain a plurality of images captured during a session, the plurality of images including a current image of a current face; extract features of the current face from the current image; compare the extracted features of the current face to extracted features of a previous face from a previous image of the plurality of images captured during the session, the previous image being obtained prior to the current image; determine, based on comparing the extracted features of the current face to the extracted features of the previous face, whether the current face from the current image matches the previous face from the previous image; and determine whether to lock access to a computing device based on whether the current face from the current image matches the previous face from the previous image.

In another example, a non-transitory computer-readable medium is provided that has stored thereon instructions that, when executed by one or more processors, cause the one or more processors to: obtain a plurality of images captured during a session, the plurality of images including a current image of a current face; extract features of the current face from the current image; compare the extracted features of the current face to extracted features of a previous face from a previous image of the plurality of images captured during the session, the previous image being obtained prior to the current image; determine, based on comparing the extracted features of the current face to the extracted features of the previous face, whether the current face from the current image matches the previous face from the previous image; and determine whether to lock access to a computing device based on whether the current face from the current image matches the previous face from the previous image.

In another example, an apparatus for processing one or more images is provided. The apparatus includes: means for obtaining a plurality of images captured during a session, the plurality of images including a current image of a current face; means for extracting features of the current face from the current image; means for comparing the extracted features of the current face to extracted features of a previous face from a previous image of the plurality of images captured during the session, the previous image being obtained prior to the current image; means for determining, based on comparing the extracted features of the current face to the extracted features of the previous face, whether the current face from the current image matches the previous face from the previous image; and means for determining whether to lock access to a computing device based on whether the current face from the current image matches the previous face from the previous image.

In some aspects, the session includes a period of time between a first time when access to the computing device was last unlocked and a second time when access to the computing device is locked after the first time.

In some aspects, the method, apparatuses, and computer-readable medium described above comprise: determining, based on comparing the extracted features of the current face to the extracted features of the previous face, that the current face from the current image matches the previous face from the previous image; and maintaining the computing device in an unlocked state based on the current face from the current image matching the previous face from the previous image.

In some aspects, the method, apparatuses, and computer-readable medium described above comprise: determining, based on comparing the extracted features of the current face to the extracted features of the previous face, that the current face from the current image is different than the previous face from the previous image; and locking access to the computing device based on the current face from the current image being different than the previous face from the previous image.

In some aspects, the method, apparatuses, and computer-readable medium described above comprise: obtaining an additional image; determining a face in the additional image matches a face in at least one previous image, the face in the at least one previous image being an authenticated face; and unlocking access to the computing device based on determining the face in the additional image matches the face in the at least one previous image.

In some aspects, the method, apparatuses, and computer-readable medium described above comprise: obtaining an additional image; determining a face in the additional image matches a face in at least one previous image, the face in the at least one previous image being rejected as an unauthenticated face; and determining not to wake up an authentication engine based on determining the face in the additional image matches the face in the at least one previous image.

In some examples, the method, apparatuses, and computer-readable medium described above comprise: receiving user credentials associated with the computing device; and unlocking access to the computing device based on the user credentials. In some examples, the user credentials include a face identification (ID) of a user authorized to access the computing device.

In some aspects, a display of the computing device is on. In such aspects, the method, apparatuses, and computer-readable medium described above further comprise: determining a first predetermined time period has elapsed since detection of one or more actions with the computing device; and causing the display of the computing device to turn off based on determining the first predetermined time period has elapsed.

In some aspects, the method, apparatuses, and computer-readable medium described above comprise: determining, based on comparing the extracted features of the current face to the extracted features of the previous face, that the current face from the current image matches the previous face from the previous image; and causing the display of the computing device to turn on based on the current face from the current image matching the previous face from the previous image.

In some aspects, the method, apparatuses, and computer-readable medium described above comprise: determining a second predetermined time period has not elapsed since at least one of detection of one or more actions with the computing device or detection of one or more faces in one or more images; and based on determining the second predetermined time period has not elapsed, extracting the features of the current face from the current image and comparing the extracted features of the current face to the extracted features of the previous face.

In some aspects, the method, apparatuses, and computer-readable medium described above comprise: determining a second predetermined time period has elapsed since at least one of detection of one or more actions with the computing device or detection of one or more faces in one or more images; and locking access to the computing device based on determining the second predetermined time period has elapsed. In some aspects, a display of the computing device is off when determining the second predetermined time period has elapsed.

In some aspects, the previous face is a previously-detected face from the previous image. In some aspects, the previous face is a previously-authenticated face from the previous image.

In some aspects, the method, apparatuses, and computer-readable medium described above comprise processing the current image using a neural network, the neural network jointly detecting the current face in the current image based on the extracted features and determining whether the current face from the current image matches the previous face from the previous image.

In some examples, the apparatus is, or is part of, a mobile device (e.g., a mobile telephone or so-called “smart phone” or other mobile device), a camera, a wearable device, an extended reality device (e.g., a virtual reality (VR) device, an augmented reality (AR) device, or a mixed reality (MR) device), a personal computer, a laptop computer, a server computer, or other device. In some aspects, the apparatus includes a camera or multiple cameras for capturing one or more images. In some aspects, the apparatus further includes a display for displaying one or more images, notifications, and/or other displayable data. In some aspects, the apparatus can include one or more sensors (e.g., one or more accelerometers, gyroscopes, inertial measurement units (IMUs), motion detection sensors, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a diagram illustrating an example of a person being authenticated for unlocking a mobile device based on one or more images captured by a camera of the mobile device, in accordance with some examples;

FIG. 2 is a flowchart illustrating an example of a process for performing biometric authentication, in accordance with some examples;

FIG. 3 is a flowchart illustrating an example of a process implementing various timeout periods in face authentication, in accordance with some examples;

FIG. 4 is a flowchart illustrating an example of a process implementing a smart timeout feature, in accordance with some examples;

FIG. 5 is a diagram illustrating an example of a face change detector that can be used when implementing the smart timeout feature, in accordance with some examples;

FIG. 6 includes images illustrating an example of a scenario when a device will be locked using the smart timeout feature, in accordance with some examples;

FIG. 7 includes images illustrating an example of another scenario when a device will be locked using the smart timeout feature, in accordance with some examples;

FIG. 8A and FIG. 8B are graphs illustrating effects of performing the face change detection during the smart timeout feature, in accordance with some examples;

FIG. 9 is a flowchart illustrating an example of a process implementing a smart wake-up feature, in accordance with some examples;

FIG. 10 is a diagram illustrating an example of a neural network architecture for the face change detector, in accordance with some examples;

FIG. 11 is a diagram illustrating another example of a neural network architecture for the face change detector, in accordance with some examples;

FIG. 12 is a diagram illustrating another example of a neural network architecture trained to jointly perform face detection and face change detection, in accordance with some examples;

FIG. 13 is a flowchart illustrating an example of a process for processing one or more images, in accordance with some examples; and

FIG. 14 is a diagram illustrating an example of a system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Object identification and object authentication (also referred to as object verification) present two related problems and have subtle differences. Object identification can be defined as a one-to-multiple problem in some cases. For example, face identification (as an example of object identification) can be used to find a person from multiple persons. Face identification has many applications, such as for performing a criminal search. Object authentication can be defined as a one-to-one problem. For example, face authentication (as an example of object authentication) can be used to check if a person is who they claim to be (e.g., to check if the person claimed is the person in an enrolled database of authorized users). Face authentication has many applications, such as for performing access control to a device (e.g., “unlocking” access to the device), system, place, or other accessible item.

Using face authentication as an illustrative example of object authentication, an enrolled database containing the features of enrolled faces can be used for comparison with the features of one or more given query face images (e.g., from input images or frames). The enrolled faces can include faces registered with the system and stored in the enrolled database, which contains known faces. An enrolled face that is the most similar to a query face image can be determined to be a match with the query face image. Each enrolled face can be associated with a person identifier that identifies the person to whom the face belongs. The person identifier of the matched enrolled face (the most similar face) is identified as the person to be recognized.

As noted above, object authentication or verification systems can be used to authenticate or verify objects. For example, using face authentication as an example, a input query face image can be compared with stored or enrolled representations of a person's face. In general, face authentication needs higher recognition accuracy since it is often related to access control of a device or system. A false positive is not expected in this case. Face authentication should be able to recognize the person for whom the face belongs with high accuracy but with low rejection rate. Rejection rate is the percentage of faces that are not recognized due to a matching score or classification result being below a threshold for recognition.

Biometrics is the science of analyzing physical or behavioral characteristics specific to each individual, in order to be able to authenticate the identity of each individual. Biometric-based authentication methods can be used to authenticate people, such as to provide access to devices, systems, places, or other accessible items. In some cases, biometric-based authentication allows a person to be authenticated based on a set of templates (verifiable data), which are unique to the person. Examples of biometric-based authentication include face authentication, fingerprint authentication, voice authentication, among others. Face authentication, for example, can compare a face of a device user in an input image with known features (e.g., stored in one or more templates) of the person the user claims to be, in order to authenticate that the user of the device is, in fact, the person. A similar process can be performed for fingerprint authentication, voice authentication, and other biometric-based authentication methods.

Biometric-based user authentication systems typically have at least two steps, including an enrollment step and an authentication step (or test step). The enrollment step captures biometric data and stores representations of the biometric data as a template. The template can then be used in the authentication step. For example, the authentication step can determine the similarity of the template against a representation of input biometric data (also referred to as user credentials, where user credentials can also include a passcode). The authentication step can use the similarity to determine whether to authenticate the user.

Systems, apparatuses, processes (or methods), and computer-readable media (referred to collectively as “systems and techniques”) are described herein that provide a smart timeout mechanism for devices. The systems and techniques can be used for any biometric-based authentication, including, but not limited to, face authentication, fingerprint authentication, voice authentication, or any other type of biometric-based authentication. In some examples, using face authentication as an illustrative example, the smart timeout mechanism can be implemented by a device using a face change detector. The face change detector can perform face change detection for images received by a camera of the device during a period of time in which the device is unlocked and the screen or display is off. The images can be captured by the device using an always-on (AON) camera. In some examples, the AON camera can be powered, controlled, and/or otherwise operated by an always-on engine (or AON engine). The

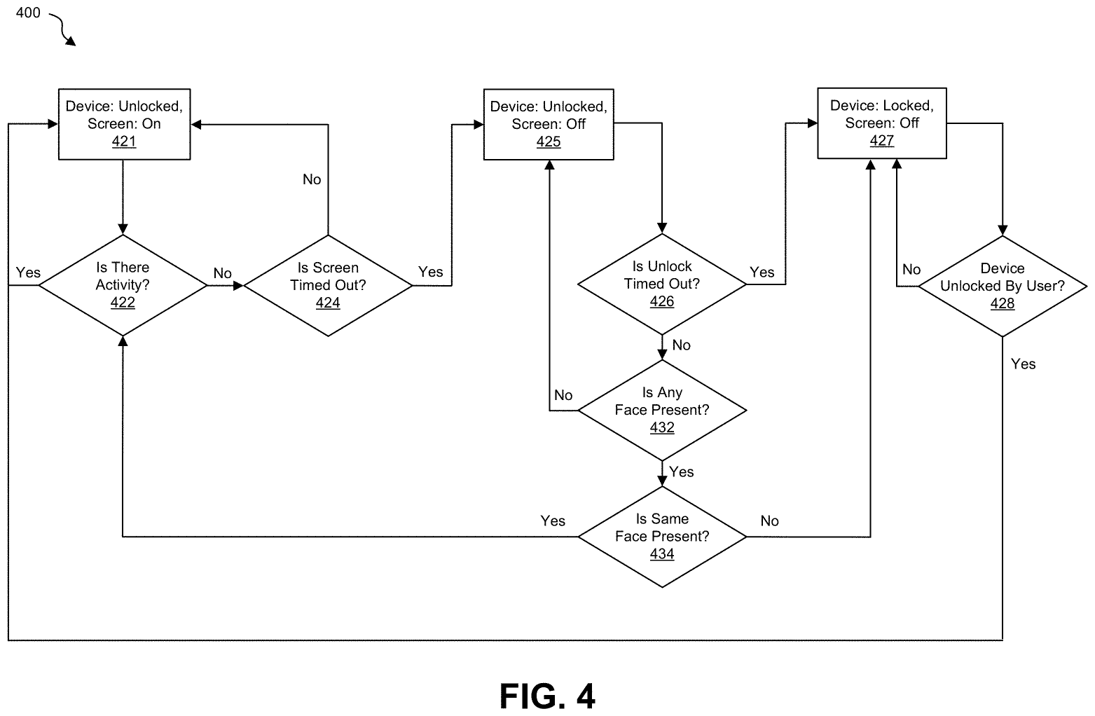

AON engine can include or be operated using a processor (e.g., a digital signal processor (DSP), central processing units (CPU), and/or other processor). Further details regarding the smart timeout mechanism and the face change detector are described below with respect to FIG. 4-FIG. 13.

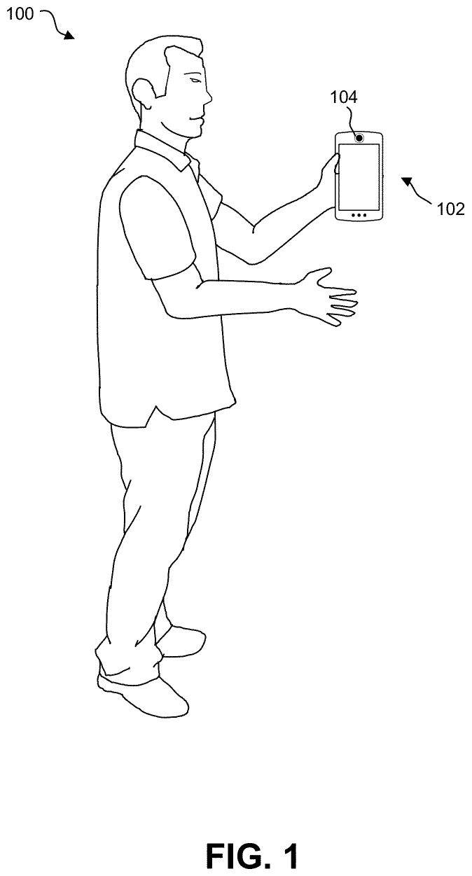

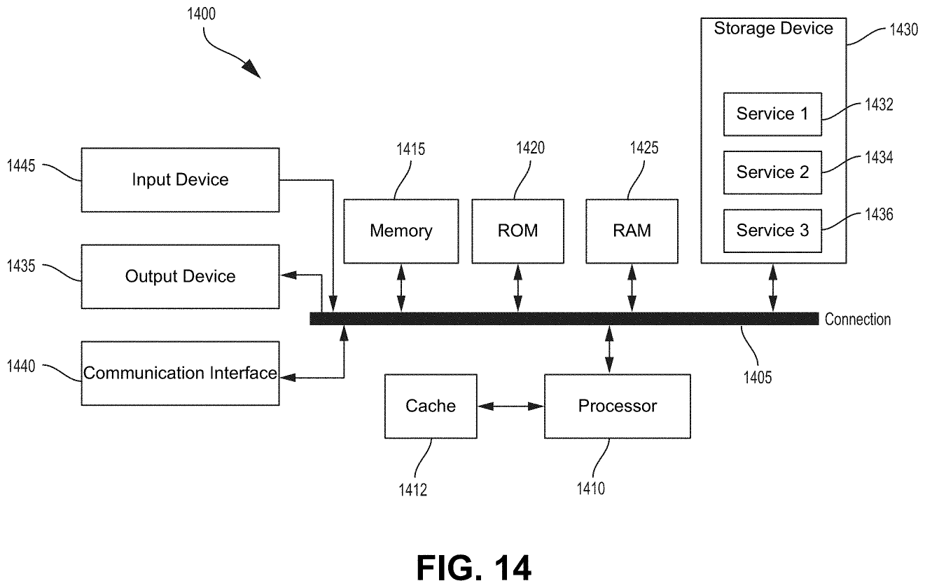

FIG. 1 is a diagram illustrating an example of a user 100 using a mobile device 102. In some examples, the mobile device 102 is a mobile phone (e.g., a smartphone with Internet and voice capabilities). In some implementations, the mobile device 102 has a system architecture similar to the computing system 1400 described below with respect to FIG. 14. In addition, the mobile device includes a front-facing camera 104 that is configured to and can capture images of a physical scene or environment within a field-of-view (FOV) of the camera 104.

In some examples, the front-facing camera 104 is an always-on (AON) camera. An AON camera is a low-power camera that passively captures images without requiring an explicit instruction (e.g., based on user input) requesting the capture of the images. In some cases, the front-facing camera 104 (as an AON camera) can have a lower frame-rate and can thus capture less images than the frame-rate of a non-AON camera. In some examples, the images captured by the front-facing camera 104 (as an AON camera) are not stored except for performing object authentication (e.g., face authentication). For instance, the images captured by the front-facing camera 104 (as an AON camera) can be temporarily cached for use by one or more processors for performing face authentication.

In some cases, the front-facing camera 104 (as an AON camera) can only be activated to start capturing images when a scene change is detected. In one illustrative example, a scene change can be detected when a change in pixel data above a scene change threshold is detected. The scene change threshold can be based on the amount of pixels in a first image that are different than corresponding pixels (at common locations) in a second image or multiple images. For instance, if at least 20% of the pixels in the first image are different than the corresponding pixels (at common locations) in the second image are different, a scene change can be detected. In some cases, the front-facing camera 104 (as an AON camera) can only be activated to start capturing images when motion is detected. IN some examples, motion can be detected using an optical motion sensor of the mobile device 102, an accelerometer, a gyroscope, an inertial measurement unit (IMU), and/or other sensor or component of the mobile device 102.

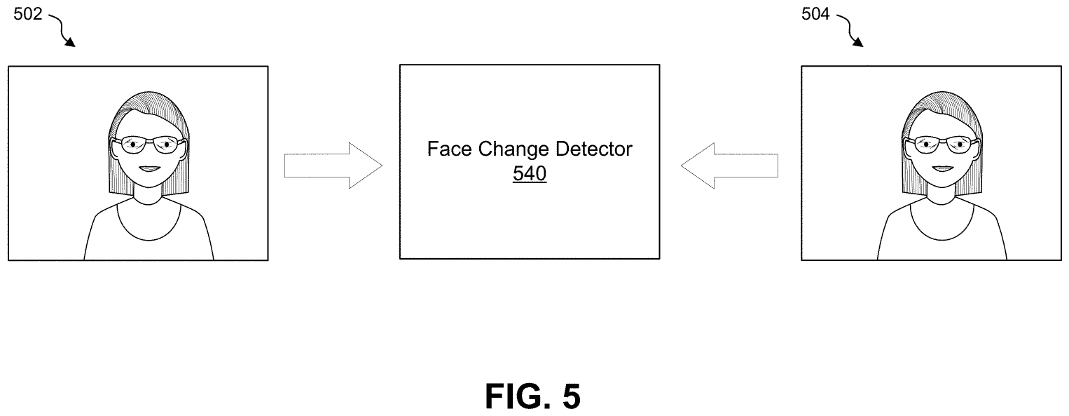

The front-facing camera 104 can capture images of the user 100 and one or more processors of the mobile device 102 can perform face authentication in order to determine whether the user 100 is authorized to access (to “unlock”) the mobile device 102. In some examples, the face authentication can be performed by comparing the face of the user 100 in one or more input images with known features (e.g., stored in one or more templates) of the person the user claims to be. If enough features of the face of the user 100 match the features stored in one or more of the templates, the one or more processors will authenticate that the user of the device is an authorized user of the mobile device 102 and is thus authorized to unlock or access the mobile device 102. An example of an authentication process 400 is described below with respect to FIG. 4. As described in more detail below, the mobile device 102 can include a face change detector 540 (shown in FIG. 5) that can be used in some cases to verify or confirm that the user 100 is an authorized user of the mobile device 102.

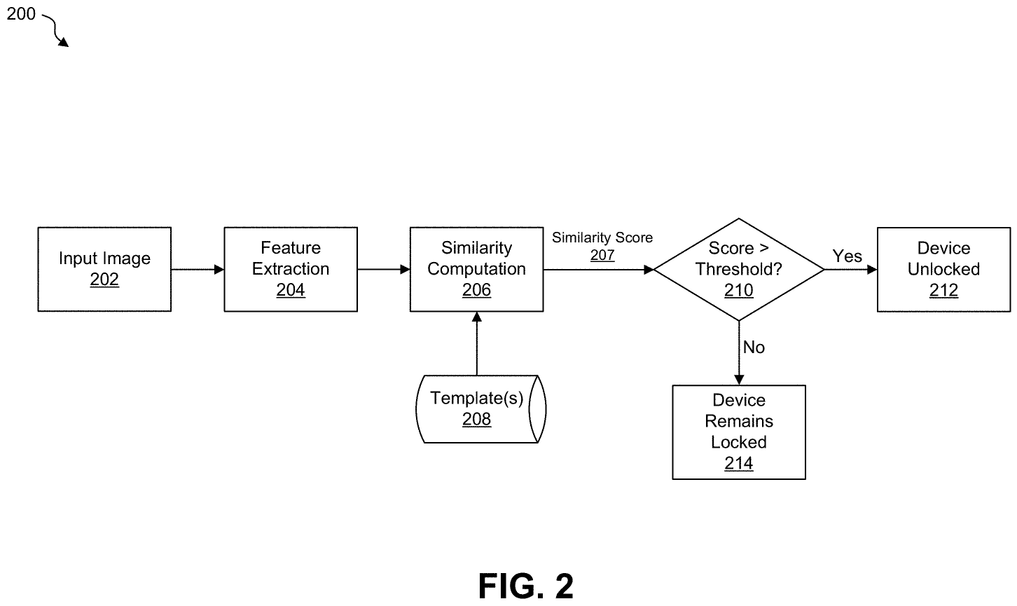

FIG. 2 is a flowchart illustrating an example of a general authentication process 200 using a face as biometric data. An input image 202 of a user attempting to access a device is received. For example, the input image 202 can be an image captured by the camera 104 of the user 100 of the mobile device 102. In some cases, a face detection engine (not shown) can be used to identify the face in the input image 202. In some examples, face localization can be performed on the input image 202 in order to determine a location of (or “localize”) the face in the image. The location of the face can be identified by a bounding region (e.g., a bounding box) around the face.

In some examples, a template matching algorithm can be used by the face detection engine to identify the face in the image 202. One example of a template matching algorithm contains four steps, including Haar feature extraction, integral image generation, Adaboost training, and cascaded classifiers. Such an object detection technique performs detection by applying a sliding window across the image 202. For each current window, the Haar features of the current window are computed from an Integral image, which is computed beforehand. The Haar features are selected by an Adaboost algorithm and can be used to classify a window as a face window or a non-face window effectively with a cascaded classifier. The cascaded classifier includes many classifiers combined in a cascade, which allows background regions of the image to be quickly discarded while spending more computation on face-like regions.

For example, the cascaded classifier can classify a current window into a face category or a non-face category. If one classifier classifies a window as a non-face category, the window is discarded. Otherwise, if one classifier classifies a window as a face category, a next classifier in the cascaded arrangement will be used to test again. Until all the classifiers determine the current window is a face, the window will be labeled as a candidate of face. After all the windows are detected, a non-max suppression algorithm can be used to group the face windows around each face to generate the final result of detected faces in the image 202. Any other suitable face detection algorithm can be used by the face detection engine to localize the face in the image 202, such as a neural network (e.g., deep learning) based object detection system or other face detection system.

In some examples, an object normalization engine (not shown) can be used for performing face normalization of the localized face in the input image 202. The object normalization engine can perform face normalization by processing the image 202 to align and/or scale the face in the image 202 for better authentication results. One example of a face normalization method uses two eye centers as reference points for normalizing faces. The face image can be translated, rotated, and scaled to ensure the two eye centers are located at the designated location with a same size. A similarity transform can be used for this purpose. Another example of a face normalization method can use five points as reference points, including two centers of the eyes, two corners of the mouth, and a nose tip. In some cases, the landmarks used for reference points can be determined by performing face landmark detection.

At block 204, the input image 202 is processed for feature extraction. For example, at block 204, a feature representation including one or more features of the face can be extracted by a feature extraction engine (not shown) from the input image 202 containing the face. In some examples, a cropped portion of the input image 202 including the image data within the bounding region identified by the face detection engine is processed for feature extraction. The feature representation of the face can be compared to a face representation (e.g., stored as a template in template storage 208) of a person authorized to access the device. In some examples, the template storage 208 can include a database. In some examples, the template storage 208 is part of the same device that is performing face authentication (e.g., mobile device 102). In some examples, the template storage 208 can be located remotely from the device (e.g., mobile device 102) performing face authentication (e.g., at a remote server that is in communication with the device).

The templates in the template storage 208 can be generated during an enrollment step, when a person is registering their biometric features for later use during authentication. Each template can be linked internally (e.g., in the template storage 208) to a subject identifier (ID) that is unique to the person being registered. For example, during enrollment (which can also be referred to as registration), an owner of the computing device and/or other user with access to the computing device can input one or more biometric data samples (e.g., an image, a fingerprint sample, a voice sample, or other biometric data). Representative features of the biometric data can be extracted by the feature extraction engine. The representative features of the biometric data can be stored as one or more templates in the template storage 208. For instance, several images can be captured of the owner or user with different poses, positions, facial expressions, lighting conditions, and/or other characteristics. Facial features of the different images can be extracted and saved as templates. For instance, a template can be stored for each image, with each template representing the features of each face with its unique pose, position, facial expression, lighting condition, etc. The one or more templates stored in the template storage 208 can be used as a reference point for performing face authentication.

As noted above, at block 204, the feature extraction engine (not shown) extracts features from the input image 202. Any suitable feature extraction technique can be used by the feature extraction engine to extract features from the biometric data (during registration and during the authentication). Various examples of feature extraction techniques that can be used by the feature extraction engine are described in Wang, et al., “Face Feature Extraction: A Complete Review,” IEEE Access, Volume 6, 2018, Pages 6001-6039, which is hereby incorporated by reference in its entirety and for all purposes. Some types of feature extraction techniques can generate handcrafted features and other types of feature extraction techniques can generate deep learning features. One illustrative example of a feature extraction process performed by the feature extraction engine that can generate deep learning features is neural network (e.g., using a deep learning network) based feature extraction. For example, a neural network can be trained using multiple training images to learn distinctive features of various face. Once trained, the trained neural network can then be applied to the input image 202 including the face. The trained neural network can extract or determine distinctive features of the face. The neural network can be a classification network including hidden convolutional layers that apply kernels (also referred to as filters) to the input image to extract features.

One illustrative example of a feature extraction process that can generate features is a steerable filter-based feature extraction process. Other examples of feature extraction techniques for generating features include a learning-based encoder, a discriminant face descriptor (DFD)-based feature extractor, among others. A steerable filter-based feature extraction process can operate to synthesize filters using a set of basis filters. For instance, the process can provide an efficient architecture to synthesize filters of arbitrary orientations using linear combinations of basis filters. Such a process provides the ability to adaptively steer a filter to any orientation. The process can also provide the ability to determine analytically the filter output as a function of orientation. In one illustrative example, a two-dimensional (2D) simplified circular symmetric Gaussian filter can be represented as:

G(x,y)=e^{-(x}^{²}^{+y}^{²}⁾,

where x and y are Cartesian coordinates, which can represent any point, such as a pixel of an image or video frame. The n-th derivative of the Gaussian is denoted as Gₙ, and the notation ( . . . )^{θ} represents the rotation operator. For example, f^{θ}(x, y) is the function f(x,y) rotated through an angle θ about the origin. The x derivative of G(x,y) is:

$${G}_{1}^{0 °} = \frac{\partial }{\partial x} G ( x , y ) = - 2 x {e}^{- ( {x}^{2} + {y}^{2} )} ,$$

and the same function rotated 90° is determined as the y derivative of G(x,y):

$${G}_{1}^{90 °} = \frac{\partial }{\partial y} G ( x , y ) = - 2 y {e}^{- ( {x}^{2} + {y}^{2} )} ,$$

where

$$\frac{\partial }{\partial x} and \frac{\partial }{\partial y}$$

are the derivative symbols, and where G₁⁰^{⁰} and G₁⁹⁰^{⁰} are called basis filters since G₁^{θ} can be represented as G₁^{θ}=cos(θ)G₁⁰^{⁰}+sin(θ)G₁⁹⁰^{⁰} and θ is an arbitrary angle, indicating that G₁⁰^{⁰} and G₁⁰^{⁹⁰} span the set of G₁^{θ} filters (hence, basis filters). Therefore, G₁⁰^{⁰} and G₁⁹⁰^{⁰} can be used to synthesize filters with any angle. The cos(θ) and sin(θ) terms are the corresponding interpolation functions for the basis filters.

Steerable filters can be convolved with images to produce orientation maps which in turn can be used to generate representations of features (e.g., represented by feature vectors) of the objects in the images, such as faces. For instance, because convolution is a linear operation, the feature extraction engine can synthesize an image filtered at an arbitrary orientation by taking linear combinations of the images filtered with the basis filters G₁⁰^{⁰} and G₁⁹⁰^{⁰}. In some cases, the features can be from local patches around selected locations on detected faces (or other objects or biometric features). Steerable features from multiple scales and orientations can be concatenated to form an augmented feature vector that represents a face image (or other biometric data). In one illustrative example, the orientation maps from G₁⁰^{⁰} and G₁⁹⁰^{⁰} can be combined to get one set of local features, and the orientation maps from G₁⁴⁵^{⁰} and G₁¹³⁵^{⁰} can be combined to get another set of local features. In some cases, the feature extraction engine can apply one or more low pass filters to the orientation maps. The feature extraction engine can use energy, difference, and/or contrast between orientation maps to obtain a local patch. A local patch can be a pixel level element. For example, an output of the orientation map processing can include a texture template or local feature map of the local patch of the face being processed. The resulting local feature maps can be concatenated to form a feature vector for the face image. Further details of using steerable filters for feature extraction are described in

William T. Freeman and Edward H. Adelson, “The design and use of steerable filters,” IEEE Transactions on Pattern Analysis and Machine Intelligence, 13(9):891-906, 1991, and in Mathews Jacob and Michael Unser, “Design of Steerable Filters for Feature Detection Using Canny-Like Criteria,” IEEE Transactions on Pattern Analysis and Machine Intelligence, 26(8):1007-1019, 2004, which are hereby incorporated by reference, in their entirety and for all purposes.

In some implementations, post-processing (e.g., Linear Discriminant Analysis, Principal Component Analysis (PCA), a combination thereof, and/or other suitable post-processing) can be performed on the feature maps to reduce the dimensionality of the feature size. In order to compensate for possible errors in landmark detection, a multiple scale feature extraction can be used to make the features more robust for matching and/or classification.

At block 206, a similarity can be computed between the feature representation of the user extracted from the input image 202 and a feature representation of the face of the person stored in a template storage 208. For example, a representation of the features extracted from the input image 202 can be compared to the one or more templates stored in the template storage 208 by a similarity determination engine (not shown). For example, at block 206, the process 200 can perform a similarity computation to compute the similarity between the input image 202 and the one or more templates in the template storage 208. The computed similarity can be used as the similarity score 207 that will be used to make the final authentication decision.

In some cases, the data of the input image 202 can also be referred to as query data (e.g., a query face). In some cases, the templates can also be referred to as enrolled data (e.g., an enrolled face). As noted above, in some examples, the features extracted for a face (or other object or biometric feature) can be represented using a feature vector that represents the face (or other object or biometric feature). For instance, each template can be a feature vector. The representation of the features extracted from the input biometric data can also be a feature vector. Each feature vector can include a number of values representing the extracted features. The values of a feature vector can include any suitable values. In some cases, the values of a feature vector can be floating numbers between −1 and 1, which are normalized feature vector values. The feature vector representing the features of the face from the input image 202 can be compared or matched with the one or more feature vectors of the one or more templates to determine a similarity between the feature vectors. For example, a similarity can be determined between the feature vector representing the face in the input image 202 and the feature vector of each template, resulting in multiple similarity values.

In some implementations, a similarity between features of an enrolled face of a template (from the template storage 208) and features of a query face (of the input image 202) can be measured with distance. Any suitable distance can be used, including Cosine distance, Euclidean distance, Manhattan distance, Mahalanobis distance, absolute difference, Hadamard product, polynomial maps, element-wise multiplication, and/or other suitable distance. In one illustrative example, a similarity between two faces can be computed as the sum of similarities of the two face patches. In some cases, the sum of similarities can be based on a Sum of

Absolute Differences (SAD) between the query face (of the input image 202) and an enrolled face of a template (from the template storage 208).

One method to represent similarity is to use similarity scores (also referred to as matching scores). A similarity score represents the similarity between features (indicating how well the features match), where a higher score between two feature vectors indicates that the two feature vectors are more similar than a lower score between two feature vectors. Referring to FIG. 2, the similarity score 207 indicates a similarity between the features of one or more of the stored templates and the facial features extracted from the input image 202. A threshold comparison engine (not shown) can compare the similarity score 207 to one or more thresholds. In some cases, a similarity score can be determined between the query face (of the input image 202) and each enrolled face (corresponding to each template). The highest similarity score (corresponding to the best match) can be used as the similarity score 207.

In some examples, a similarity score can be generated based on a computed distance between the facial features extracted from the input image 202 and template data, or based on any other comparison metric. As previously described, a distance can include a Cosine distance, Euclidean distance, Manhattan distance, Mahalanobis distance, absolute difference,

Hadamard product, polynomial maps, element-wise multiplication, and/or other suitable distance. As noted above, a feature vector for a face can be generated based on the feature extraction performed by the feature extraction engine. A similarity score between the face in the input image 202 and the template data can be computed based on a distance between a feature vector representing the face and a feature vector representing the template data. The computed distance represents the difference between data values of the feature vector representing the face in the input image 202 and data values of the feature vector representing the template data. For instance, a cosine distance measures the cosine of the angle between two non-zero vectors of an inner product space. The cosine similarity represents a measure of similarity between the two non-zero vectors. In one illustrative example using cosine as a distance metric, a cosine similarity can be computed as:

$$Cosine Similarity = \frac{{\sum }_{i = 1}^{n} {x}_{i} {y}_{i}}{\sqrt{{\sum }_{i = 1}^{n} {x}_{i}^{2}} \sqrt{{\sum }_{i = 1}^{n} {y}_{i}^{2}}} ,$$

where x and y are components of vector x and y, respectively. The resulting cosine similarity ranges from −1 (indicating the vector values are opposites) to 1 (indicating the vector values are the same). A 0 similarity value indicates orthogonality or decorrelation, while similarity values between −1 and 1 (other than 0) indicate intermediate similarity or dissimilarity. The corresponding cosine distance is then defined as:

Cosine Distance=1−Cosine Similarity.

In some cases, a computed distance (e.g., Cosine distance, Euclidean distance, and/or other distance) can be normalized to a value of 0 or a value of 1. As one example, the similarity score can be defined as 1000*(1-distance). In some cases, the similarity score can be a value between 0 and 1.

As noted above, the similarity score 207 can be used to make the final authentication decision. For example, at block 210, the similarity score 207 can be compared to a similarity threshold. In some examples, the similarity threshold can include a percentage of similarity (e.g., 75%, 80%, 85%, etc. of the features are similar). If the similarity score 207 is greater than the similarity threshold, the device is unlocked at block 212. However, if the similarity score 207 is not greater than the threshold, the device remains locked at block 214.

In some implementations, devices (e.g., mobile devices such as phones) utilizing face authentication implement an unlock timeout period. An unlock timeout period is a period of inactivity on the device (when unlocked), after which the device is automatically locked and a new face authentication will need to be performed to unlock the device. In some examples, such devices may also implement a separate screen timeout period. A screen timeout period is a period of inactivity on the device (when the screen or display of the device is active or “on”) after which the screen or display of the device is automatically turned off (e.g., the screen or display is powered off). The device may continue to remain unlocked when the screen or display is turned off.

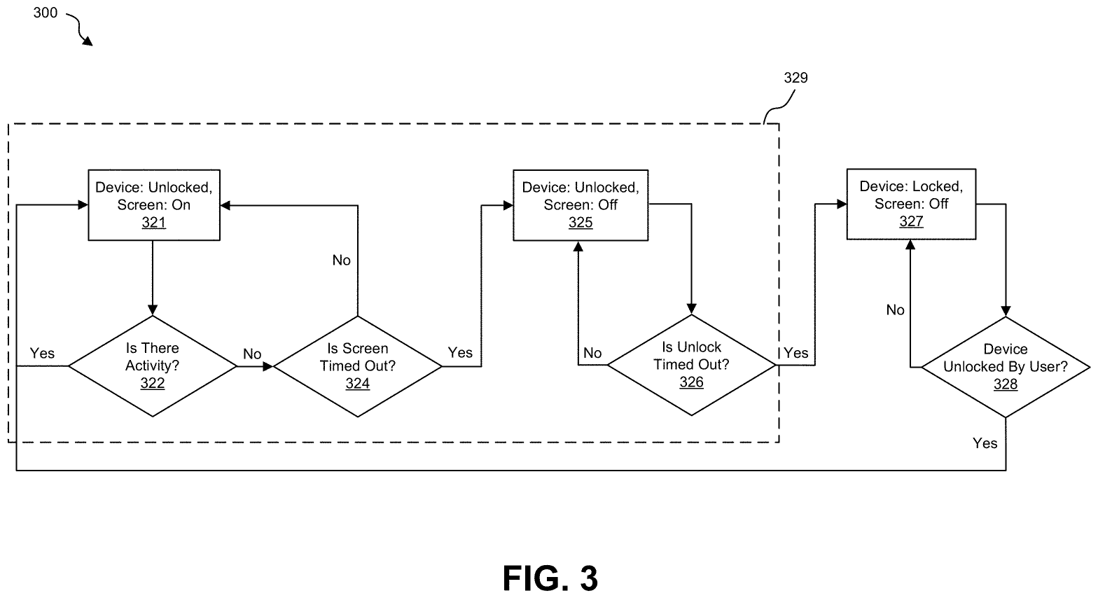

FIG. 3 is a flowchart illustrating an example of a process 300 using unlock and screen timeout periods for a device. Block 321 illustrates a state of the device where the device is unlocked and the screen (or display) of the device is on. For instance, the device can be unlocked by an authorized user at block 328 based on face authentication being performed using one or more images of the authorized user captured by a front-facing camera (e.g., an AON camera) of the device. At block 322, the process 300 determines whether there is any activity associated with the phone. For example, the device can detect whether any actions have been performed with or using the computing device, such as a user interacting with the device, opening and/or closing of applications on the device, typing using the device, detected movement of the device (e.g., as measured by one or more sensors, such as one or more IMUs, accelerometers, gyroscopes, etc.), motion detected relative to the device (e.g., as measured by an optical motion sensor or other sensor), sound or audio commands detected by the device (e.g., detected using a voice recognition algorithm), and/or other activity or action.

If, at block 322, activity with respect to the device is detected while the device is unlocked and the screen is on, the process 300 maintains the device in the unlocked state with the screen or display turned on (as shown by block 321). In the event activity with respect to the device is not detected at block 322, the process 300 determines at block 324 whether a screen timeout period has elapsed. As noted above, the screen timeout period is a period of inactivity on the device after which the screen or display of the device is automatically turned off, in which case the device may continue to remain unlocked. The screen timeout period can be set to any suitable amount by a manufacturer (e.g., an original equipment manufacturer or OEM) and/or by an authorized user of the device. In one illustrative example, the screen timeout period can be set to a period of 10 seconds. The process 300 can determine that the screen timeout period has elapsed when there is no activity detected at block 322 for the duration of the timeout period. In some examples, the process 300 can periodically check whether the screen timeout period has elapsed, such as every 500 milliseconds (ms), 1 second, 2 seconds, 3 seconds, or other period of time.

If it is determined at block 324 that the screen timeout period has not elapsed, the process 300 maintains the device in the unlocked state with the screen or display turned on (as shown by block 321). In the event the process 300 determines at block 324 that the screen timeout period has elapsed (there is no activity detected at block 322 for the duration of the timeout period), the process 300 turns the screen or display of the device off (e.g., powers down the display), resulting in the state illustrated in block 325 where the device is unlocked and the screen or display is off

When the device is unlocked and the screen is off (the state shown at block 325), the process 300 can determine at block 326 whether an unlock timeout period has elapsed. As noted above, the unlock timeout period is a period of inactivity on the device (when unlocked), after which the device is automatically locked. The unlock timeout period can be set to any suitable amount by the manufacturer and/or by an authorized user of the device. In one illustrative example, the unlock timeout period can be set to a period of 20 seconds. In some examples, the process 300 can periodically check whether the unlock timeout period has elapsed, such as every 500 milliseconds (ms), 1 second, 2 seconds, 3 seconds, or other period of time. In some cases, when the device is in the state shown at block 325 (the device is unlocked and the screen is off), the process 300 can determine whether there is any activity (similar to that described above with respect to block 322) detected within the unlock timeout period. In such cases, if there is activity detected (e.g., a power button being selected, pressed, etc.), the screen or display can be turned on, resulting in the device being placed in the state shown at block 321 (the device is unlocked and the screen is on).

In the event the process 300 determines at block 326 that the unlock timeout period has not elapsed, the process 300 maintains the device in the unlocked state with the screen or display turned off (as shown by block 325). If it is determined at block 326 that the unlock timeout period has elapsed (e.g., there is no activity detected for the duration of the unlock period), the process 300 locks the device, resulting in the state illustrated in block 327 where the device is locked and the screen or display is off. When locked, the device cannot be accessed for performing various functions, such as making phone calls (except in some cases emergency phone calls), accessing mobile applications, accessing an Internet browser, among other functions the device provides.

After the device is locked and is in the state shown by block 327 (the device is locked and the screen or display is off), a new face authentication will need to be performed to unlock the device. In some cases, a user can enter a passcode (e.g., a numeric or alphanumeric passcode) to unlock the device. The face information (e.g., a face identification or ID of a users face), passcode, and/or other input information used for authentication can be referred to as user credentials. At block 328, the process 300 can determine whether an authorized user has unlocked the device, such as using face authentication or passcode-based authentication. If the device has not been unlocked, the device is maintained in the state shown by block 327 (the device is locked and the screen or display is off). If the process 300 determines at block 328 that the device is unlocked by an authorized user, the process 300 proceeds to place the device in the state shown in block 321 where the device is unlocked and the screen or display is powered on.

Issues can be encountered when performing a process such as the process 300 described above with respect to FIG. 3. For example, during the screen and unlock timeout periods (as highlighted by the dotted outline 329 in FIG. 3), any user can access the device because the device is unlocked and no further authentication or verification of an authorized user is required to access the phone. Such a scenario results in a security risk. Because of such a security risk, users are motivated to have a short unlock timeout period in order to prevent unauthorized users from accessing the users' devices. A short unlock timeout period can have a large impact on user experience, such as by requiring more frequent re-authentications, higher latency, an increase in false positives, etc.

In some cases, requiring a user to be re-authenticated can impact the user experience negatively in at least two ways, including increasing latency and false negative authentications. For example, performing face authentication has some perceivable latency (e.g., it can take 100 ms, 200ms, 500ms, or other period of time to perform the face authentication). Such latency can frustrate an authorized user, especially if the user has been authenticated recently. With respect to false negative authentications, each time a valid or authorized user presents the user's face for face authentication, there is a chance that the face authentication algorithm will erroneously recognize the valid face as an invalid face. Such an incorrect determination is referred to as a false negative (or false negative authentication). A false negative can impact user experience by requiring a user reposition the user's face or wait for some amount of delay before a subsequent face authentication can be performed to correctly identify the user as a valid or authorized user. The latency impacts of re-authentication cannot generally be avoided by performing constantly face authentication in the background without consuming significant amounts of power.

As noted above, systems and techniques are described herein that provide a smart timeout mechanism for devices. The systems and techniques can be used for any biometric-based authentication, including, but not limited to, face authentication, fingerprint authentication, voice authentication, or any other type of biometric-based authentication. For illustrative purposes, examples will be described herein using faces of people as illustrative examples of objects and biometric data representing the objects. In such examples, an image of a face can be used as biometric input data. For instance, one illustrative example of a use case for the user-adaptive biometric authentication techniques described herein is for face authentication for accessing mobile devices. However, one of ordinary skill will appreciate that the techniques described herein can be applied to any other object (other than a face or person) for which biometric data can be obtained. One of ordinary skill will also appreciate that the techniques described herein can be applied using any type of biometric data, such as fingerprint data, voice data, and/or other biometric data.

FIG. 4 is a flowchart illustrating an example of process 400 that implements a smart timeout feature for face authentication. The smart timeout mechanism is implemented in the process 400 by introducing blocks 432 and 434. For block 434, a face change detector 540 (shown in FIG. 5) of the device can perform face change detection for images received by a camera of a device during a period of time in which the device is unlocked and the screen is off (a device state shown in FIG. 4 as block 425). The device can capture the images using an always-on (AON) camera (e.g., controlled by an AON engine), such as the camera 104 of the device 102 shown in FIG. 1. For example, as described above, the camera 104 (as an AON camera) can continuously and passively capture images of a scene within a FOV of the camera 104. The images are captured automatically without user input being needed to initiate the capture of the images.

Using the AON camera, the device can continuously monitor the face of any user in images captured during a period of time in which the device is unlocked and the screen is off (as shown by the state in block 425) by performing face change detection as part of the process 400. In some cases, the period of time starting from when access to the computing device was last unlocked and a time when access to the computing device is locked can be referred to as a session. In some cases, a session includes a period of time starting from when the screen of the computing device was last turned off (while the device is unlocked) to a time when access to the computing device is locked.

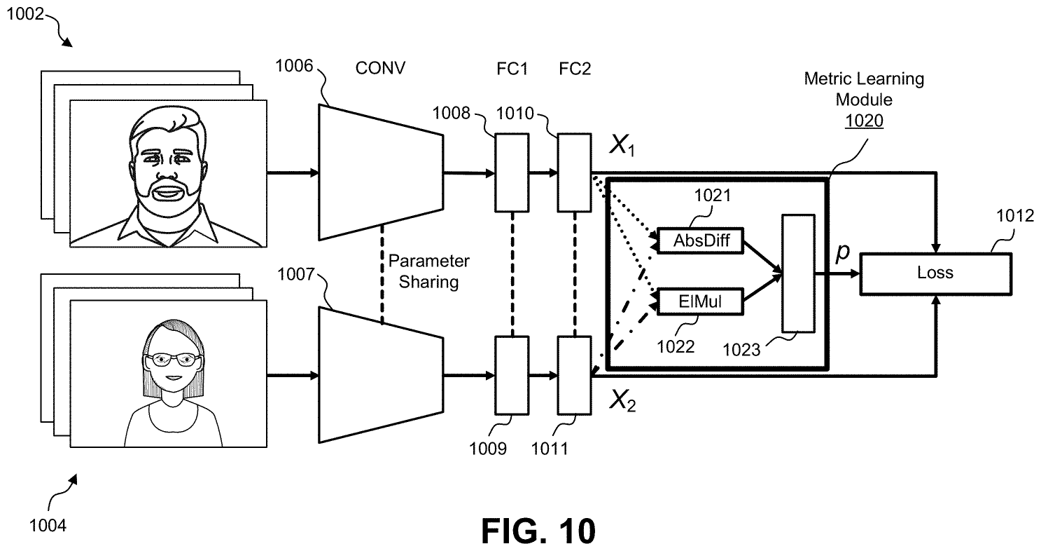

As described in more detail below, the face change detector 540 can perform face change detection by determining whether the difference between a previously detected face from a previous image and a currently detected face from a current image (a “face change”) is large. For instance, the face change detector 540 can determine a face change is large when the face change is determined to be larger than a face change threshold. If the face change is larger than the face change threshold, the unlock timeout period can be truncated (e.g., the unlock timeout period is determined to have expired upon determining the face change is larger than the threshold) and any authorized user will need to be re-authenticated in order to access the device. In some cases, whether the face change threshold is met can be determined by a neural network of the face change detector (e.g., by determining when two feature vectors X₁ and X₂ from two faces in two different images are of the same person, as described below with respect to FIG. 10-FIG. 12). In some cases, the face change detection is only used during a period of time in which the device is unlocked and the screen is off (as shown by the state in block 425). For instance, re-authentication can be performed using the process described with respect to FIG. 1-FIG. 3 and not using the face change detection. Details regarding example implementations of the face change detector 540 are described below with respect to FIG. 10-FIG. 12.

Similar to block 321 of FIG. 3, block 421 of the process 400 illustrates a state of the device where the device is unlocked and the screen or display of the device is on. As described above, an authorized user at block 428 can unlock the device using face authentication performed using one or more images of the authorized user captured by the front-facing camera (e.g., an AON camera) of the device. At block 422, the process 400 determines whether there is any activity associated with the phone. As noted above, examples of activity can include a user interacting with the device, opening and/or closing of applications on the device, typing using the device, detected movement of the device (e.g., as measured by one or more sensors, such as one or more IMUs, accelerometers, gyroscopes, etc.), motion detected relative to the device (e.g., as measured by an optical motion sensor or other sensor), sound or audio commands detected by the device (e.g., detected using a voice recognition algorithm), and/or other activity or action.

If the process 400 detects at block 422 activity with respect to the device while the device is unlocked and the screen is on, the process 400 maintains the device in the state shown by block 421. If the process 400 does not detect any activity with respect to the device when the device is unlocked and the screen is on, the process 400 determines whether the screen timeout period has elapsed at block 424, similar to that described above with respect to FIG. 3. The process 400 can determine that the screen timeout period has elapsed when there is no activity detected at block 422 for the duration of the timeout period. In some examples, the process 400 can periodically check whether the screen timeout period has elapsed (e.g., every 500 milliseconds (ms), 1 second, 2 seconds, 3 seconds, or other period of time).

If the process 400 determines at block 424 that the screen timeout period has not elapsed, the process 400 maintains the device in the unlocked state with the screen or display turned on (in the state shown by block 321). If the process 400 determines that the screen timeout period has elapsed at block 424 (there is no activity detected at block 422 for the duration of the screen timeout period), the process 400 proceeds to turn the screen or display of the device off (e.g., by powering down the display). A result of turning the screen or display off is that the device will be in the state illustrated in block 425, where the device is unlocked and the screen or display is off.

When the device is unlocked and the screen is off (the state shown at block 425), the process 400 can perform the smart timeout mechanism discussed above. For example, the process 400 can determine at block 426 whether an unlock timeout period has elapsed. Similar to that described with respect to the process 300 of FIG. 3, the unlock timeout period is a period of inactivity on the device (when unlocked), after which the device is automatically locked. In some examples, the process 400 can periodically check whether the unlock timeout period has elapsed (e.g., every 500 milliseconds (ms), 1 second, 2 seconds, 3 seconds, or other period of time).

If the process 400 determines at block 426 that the unlock timeout period has not elapsed, the process 400 determines at block 432 whether any face is present in one or more images captured during a current session. As noted above, the current session can include the period of time starting from when access to the computing device was last unlocked and ending at a next time at which access to the computing device is locked (at block 427), or can include the period of time starting from when the screen of the computing device was last turned off (at block 425) to the time when access to the computing device is locked (at block 427). If no face is detected in a given image captured during the current session, the process 400 maintains the device in the unlocked state with the screen or display turned off (as shown by block 425). Because a face is not detected in the image, the device can safely remain unlocked and the screen turned off without any security risk since a user (either authorized or unauthorized) is not attempting to use the phone.

If a face is detected in a current image (referring to an image currently being processed) captured during the current session, the process 400 determines at block 434 whether the face detected in the current image is the same face as a face detected in a previous image. In some implementations, the previous image that is compared to the current image can include the image for which the user's face was authenticated (at block 428) to unlock the device. In some implementations, the previous image that is compared to the current image can include the image in which a face was last detected. The determination of whether the face in the current image is the same as the face from the previous image can be based on a result of the face change detection performed by the face change detector 540 shown in FIG. 5, as noted above. For example, the face change detector can perform face change detection to determine whether the face change difference between the face detected in the previous image (e.g., previous image 502) and the face detected in the current image (e.g., current image 504) is large. A face change threshold can be used to determine whether the face change is large enough to consider the faces as different faces. For instance, if the face change is less than the face change threshold, the process 400 at block 434 can determine that the face in the current image is the same face as the face in the previous image. The process 400 can then proceed to block 422 to determine whether there is any activity. If activity is determined at block 422, the process 400 can return the device to the state shown in block 421 (the device is unlocked and the screen is on). In some cases, the device is returned to the state shown in block 421 in response to determining at block 434 that the face in the current image is the same face as the face in the previous image (e.g., without determining whether there is activity at block 422). In some examples, the face change detection process is performed only when a face is detected in the FOV of the camera.

If the face change is determined to be greater or larger than the face change threshold, the process 400 at block 434 can determine that the face in the current image is a different face (i.e., is not the same face) as the face in the previous image. In such cases, the unlock timeout period is truncated (e.g., the unlock timeout period is determined to have expired upon determining the face change is larger than the face change threshold) and the process 400 locks the device. As a result, the device is placed in the state illustrated in block 427 (the device is locked and the screen or display is off). When locked, the device cannot be accessed for performing various functions, such as making phone calls (except in some cases emergency phone calls), accessing mobile applications, accessing an Internet browser, among other functions the device provides. Once the device is locked and is in the state shown in block 427, a new face authentication or other biometric authentication will need to be performed to unlock the device.

At block 428, the process 400 can determine whether an authorized user has unlocked the device. As described above, a user can unlock the device by providing user credentials that are used for face authentication (e.g., using a face ID of the user), passcode-based authentication (using a passcode), or other authentication technique (e.g., using a fingerprint scanner or other technique). The device is maintained in the state shown in block 427 (the device is locked and the screen or display is off) until the device is unlocked based on authentication of an authorized user. At block 428, if the process 400 determines that the device is unlocked by an authorized user, the process 400 proceeds to unlock the device and turn on the screen of display (as shown by the state shown in block 421).

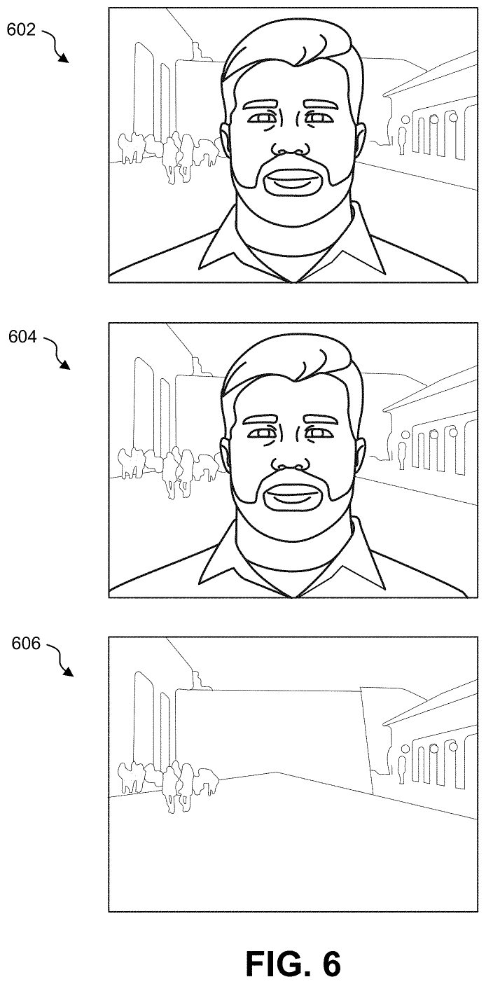

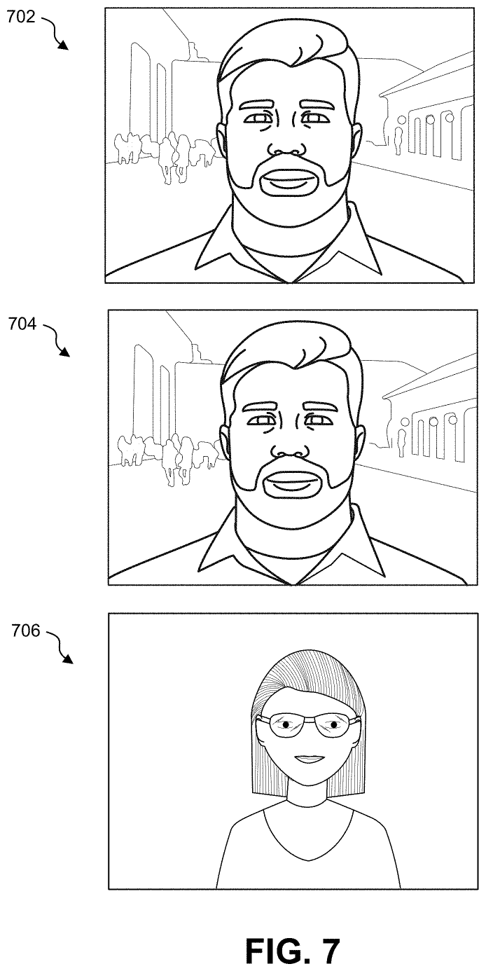

FIG. 6 and FIG. 7 include images illustrating examples of scenarios of when a device will be locked using the smart timeout mechanism described above. FIG. 6 illustrates an example where a person's face is present in one or more images and is not present in a subsequent image. The images are those captured during a session as described above, where a session can include a period of time starting from when access to the computing device was last unlocked to a next time at which access to the computing device is locked, or a period of time starting from when the screen of the computing device was last turned off to the time when access to the computing device is locked. For example, as shown in FIG. 6, the image 602 and the image 604 include a face of a person. However, the face of the person is not present in the image 606. If the face of the person is not in any image for the unlock period of time, the device can be locked.

FIG. 7 illustrates an example where a first person's face is present in one or more images and a second person's face is present in a subsequent image, where the images captured during a given session. For example, as shown in FIG. 7, the image 702 and the image 704 include a face of a first person. A face of a second person is present in the image 706. Based on the face change detection, the device can determine that the face of the second person in image 706 is different than the face of the first person in the images 702 and 704. The device can be locked in response to the face change determination.

The implementation of the smart timeout mechanism and face change detection described above provides advantages as compared to systems and processes that implement only screen and unlock timeout periods. For instance, the smart timeout feature can eliminate the period in which any user can access the phone, as the unlock timeout period is truncated when a face other than a previously-authenticated face is detected in an image of a given session. The smart timeout feature thus provides increased security measures for device access.

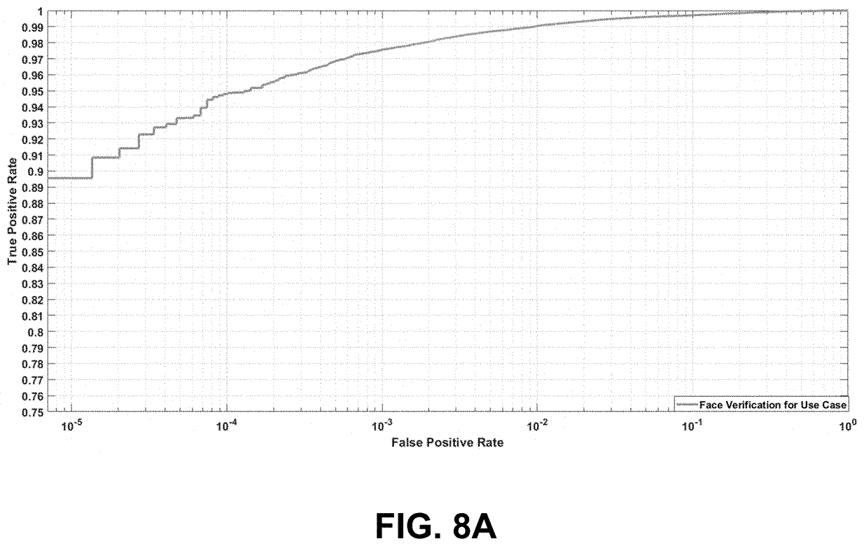

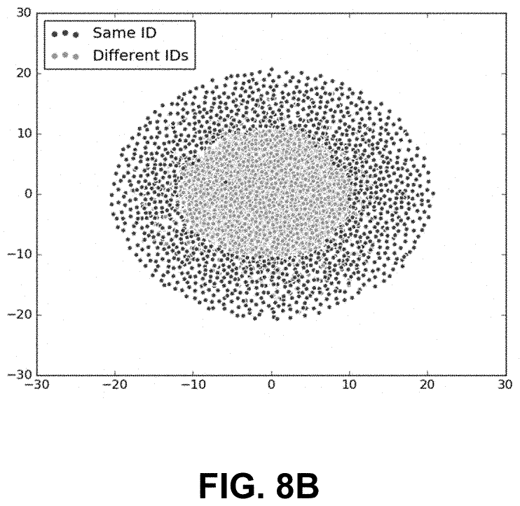

As another advantage, detecting whether or not a face change has occurred is a fundamentally lower power operation as compared to performing full biometric-based authentication (e.g., face authentication) using a dictionary of enrolled faces (e.g., stored as templates in template storage 208). The smart timeout feature thus provides an increase in power savings. The face change detection does not require face enrollment (for template storage) or face localization, which contributes the power savings. Table 1 below provides an example of the reduced complexity of the face change detection as compared to face authentication using templates. For example, the number of neural network parameters for the template-based face authentication is 8.77 million (M) parameters, whereas the number of neural network parameters for the face change detection is 0.085M . Also, the face change detection has 0.01% of the number of Multiply Accumulate (MAC) units as compared to the template-based face authentication (2564M versus 0.185M). In addition, the graphs shown in FIG. 8A and FIG. 8B illustrate the accurate nature of the face change detection even in view of the reduced complexity. As shown by the line plotted on the graph, the face change detection has a high true positive rate (90% or above).

TABLE 1

| | | Number of |
|---|---|---|
| | MAC Count | Parameters |
| Face Authentication | 2564M | 8.77M |
| Using Stored Templates | | |
| Face change detection | 0.185M | 0.085M |

The smart timeout feature also provides an enhanced user experience. For example, while the previously-authenticated user is in the field of view of the device's camera, the device will remain unlocked and thus will limit the amount of authentications that need to be performed by the user to unlock the device. At the same time, if a different user attempts to access the phone, the device will be automatically locked (based on the face change detection).

In some examples, a smart wake-up feature or mechanism may be used as an alternative to or in addition to the smart timeout feature. To implement the smart wake-up feature, a device can continuously or periodically perform face change detection. The device can be unlocked or remain unlocked and in some cases the screen or display can be turned on if the face change detection determines a face change that is less than the face change threshold described above. The device can remain locked or can be locked if the face change is determined to be greater than the face change threshold.

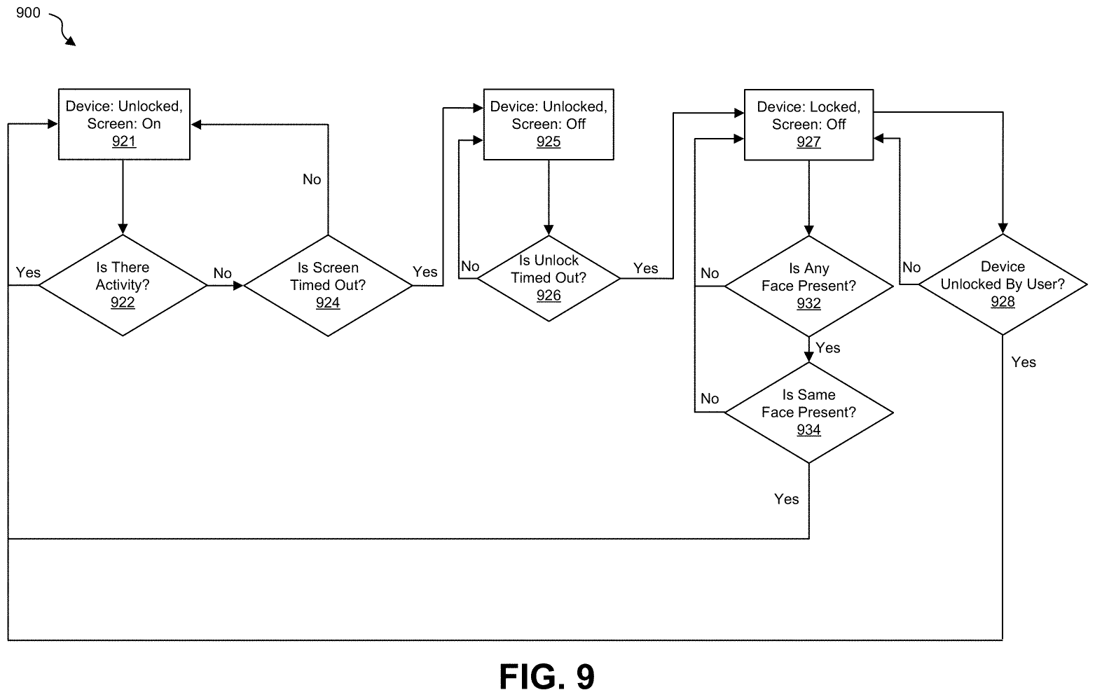

FIG. 9 is a flowchart illustrating an example of process 900 that implements a smart wake-up feature for face authentication for a device. Similar to that described above with respect to FIG. 4, the face change detector 540 of FIG. 5 of the device can perform face change detection at block 934 of process 900. For instance, the face change detector 540 can perform the face change detection for images received by a camera of the device during a period of time in which the device is locked and the screen is off (a device state shown in FIG. 9 as block 927). In some examples, the face change detector 540 can perform the face change detection for images received by the camera during a period of time after the unlock is determined to be timed out (at block 926) and before the device is placed in the state shown in block 927 (when the device is locked and the screen is off). As described herein, the device can capture the images using an always-on (AON) camera, such as the camera 104 of the device 102 shown in

FIG. 1. For example, the camera 104 (as an AON camera) can continuously and passively capture images of a scene within a FOV of the camera 104. The images are captured automatically without user input being needed to initiate the capture of the images. As noted above, in some cases the AON camera can be controlled by an AON engine. In some examples, the AON engine can control the smart wake-up feature and/or the smart timeout feature.

As described herein, the face change detector 540 can perform the face change detection by determining whether a face change (e.g., the difference between a previously detected face from a previous image and a currently detected face from a current image) is large based on the face change threshold. For instance, the face change detector 540 can determine a face change is large when the face change is determined to be larger than the face change threshold. A neural network of the face change detector can be used to determine whether the face change threshold is met (e.g., by determining when two feature vectors X₁ and X₂ from two faces in two different images are of the same person, as described below with respect to FIG. 10-FIG. 12).

Block 921 of the process 900 illustrates a state of the device in which the device is unlocked and the screen or display of the device is on. In some cases, an authorized user at block 928 can unlock the device using face authentication performed using one or more images of the authorized user captured by the front-facing camera (e.g., an AON camera) of the device. At block 922, the process 900 determines whether there is any activity associated with the phone. As noted above, examples of activity can include a user interacting with the device, opening and/or closing of applications on the device, typing using the device, detected movement of the device (e.g., as measured by one or more sensors, such as one or more IMUs, accelerometers, gyroscopes, etc.), motion detected relative to the device (e.g., as measured by an optical motion sensor or other sensor), sound or audio commands detected by the device (e.g., detected using a voice recognition algorithm), and/or other activity or action.

If the process 900 detects at block 922 activity with respect to the device while the device is unlocked and the screen is on, the process 900 maintains the device in the state shown by block 921. If the process 900 does not detect any activity with respect to the device when the device is unlocked and the screen is on, the process 900 determines whether the screen timeout period has elapsed at block 924. The process 900 can determine that the screen timeout period has elapsed when there is no activity detected at block 922 for the duration of the timeout period. In some examples, the process 900 can periodically check whether the screen timeout period has elapsed (e.g., every 500 milliseconds (ms), 1 second, 2 seconds, 3 seconds, or other period of time).

If the process 900 determines at block 924 that the screen timeout period has not elapsed, the process 900 maintains the device in the unlocked state with the screen or display turned on (in the state shown by block 321). If the process 900 determines that the screen timeout period has elapsed at block 924 (there is no activity detected at block 922 for the duration of the screen timeout period), the process 900 proceeds to turn the screen or display of the device off (e.g., by powering down the display). A result of turning the screen or display off is that the device will be in the state illustrated in block 925, where the device is unlocked and the screen or display is off.

When the device is unlocked and the screen is off (the state shown at block 925), the process 900 can determine at block 926 whether an unlock timeout period has elapsed. As described above, the unlock timeout period is a period of inactivity on the device (when unlocked), after which the device is automatically locked. In some examples, the process 900 can periodically check whether the unlock timeout period has elapsed, such as every 500 milliseconds (ms), 1 second, 2 seconds, 3 seconds, or other period of time. In some cases, when the device is in the state shown at block 925 (the device is unlocked and the screen is off), the process 900 can determine whether there is any activity (similar to that described above with respect to block 922) detected within the unlock timeout period. In such cases, if there is activity detected (e.g., a power button being selected, pressed, etc.), the screen or display can be turned on, resulting in the device being placed in the state shown at block 921 (the device is unlocked and the screen is on).

If the process 900 determines at block 926 that the unlock timeout period has not elapsed, the process 900 maintains the device in the unlocked state with the screen or display turned off (as shown by block 925). If the process 900 determines at block 926 that the unlock timeout period has elapsed (e.g., there is no activity detected for the duration of the unlock period), the process 900 can lock the device, resulting in the device being placed in the state illustrated in block 927 (the device is locked and the screen or display of the device is off). As noted above, when locked, the device cannot be accessed for performing various functions, such as making phone calls (except in some cases emergency phone calls), accessing mobile applications, accessing an Internet browser, among other functions the device provides.

When the device is locked and the screen is off (the state shown at block 927), the process 900 can perform the smart wake-up feature or mechanism discussed above. For example, the process 900 can determine at block 932 whether any face is present in one or more images captured during a current session. As used with respect to FIG. 9, a session can include the period of time in which the device is locked and the screen is off (the device state shown in block 927) in some examples. In some examples, the session can also or alternatively include the period of time after the unlock is determined to be timed out (at block 926) and before the device is placed in the state shown in block 927 (when the device is locked and the screen is off). If the process determines at block 932 that no face is detected in a given image captured during the current session, the process 900 maintains the device in the locked state with the screen or display turned off (as shown by block 927). In the event the current session includes the period of time after the unlock timeout is determined at block 926 and before the device enters the state of block 927, the process 900 can proceed to place the device in the state shown in block 927 (the device is locked and the screen is off).

If a face is detected in a current image (an image currently being processed) captured during the current session, the process 900 determines at block 934 whether the face detected in the current image is the same face as a face detected in a previous image. In some cases, the previous image that is compared to the current image can include the image for which the user's face was authenticated (at block 928) to unlock the device. In some implementations, the previous image that is compared to the current image can include the image in which a face was last detected. The determination of whether the face in the current image is the same as the face from the previous image can be based on a result of the face change detection performed by the face change detector 540 shown in FIG. 5, as noted above. For example, the face change detector can perform face change detection to determine whether the face change difference between the face detected in the previous image (e.g., previous image 502) and the face detected in the current image (e.g., current image 504) is large. The face change threshold described above can be used to determine whether the face change is large enough to consider the faces as different faces. For instance, if the face change is less than the face change threshold, the process 900 at block 934 can determine that the face in the current image is the same face as the face in the previous image. The process 900 can return the device to the state shown in block 921 (the device is unlocked and the screen is on) in response to determining at block 934 that the face in the current image is the same face as the face in the previous image. In some examples, the face change detection process is performed only when a face is detected in the FOV of the camera.

If the face change is determined to be greater or larger than the face change threshold, the process 900 at block 934 can determine that the face in the current image is a different face (i.e., is not the same face) as the face in the previous image. Based on determining the face change is greater than the face change threshold (and thus the face in the current image is different from the face in the previous image), the process 900 maintains the device in the locked state with the screen or display turned off (as shown by block 927). In some examples, when in the state shown by block 927, the process 900 can perform the operations of blocks 932 and 934 and can also perform the operation of block 928.

In some examples, the process 900 can include determining (e.g., by the AON engine) to not wake up a main authentication engine that performs full face authentication (e.g., the authentication process described with respect to FIG. 2 and FIG. 3), based on the AON engine being aware from the face change detection that the same face has previously been rejected by the main authentication engine. Such a solution is advantageous over cases when the AON engine wakes up the main authentication engine for authenticating a face each time the AON engine detects a face in an image. In such cases, the device will be unlocked if an authenticated user's face is determined, and will be powered down while keeping the AON engine active if an authenticated user's face is not determined. When the AON engine detects another face after previously determining a face is not of an authenticated user, the AON engine will again wake up the main authentication engine for face authentication. Using the smart wake-up feature based on the face change detection, the power of the device will be conserved because the main authentication engine (which consumes more power than the AON engine) of the device will be activated or woken up at a reduced rate.

At block 928, the process 900 can determine whether an authorized user has unlocked the device. As described above, a user can unlock the device by providing user credentials that are used for face authentication (e.g., using a face ID of the user), passcode-based authentication (using a passcode), or other authentication technique (e.g., using a fingerprint scanner or other technique). At block 928, if the process 900 determines that the device is unlocked by an authorized user, the process 900 proceeds to unlock the device and turn on the screen of display (as shown by the state shown in block 921).

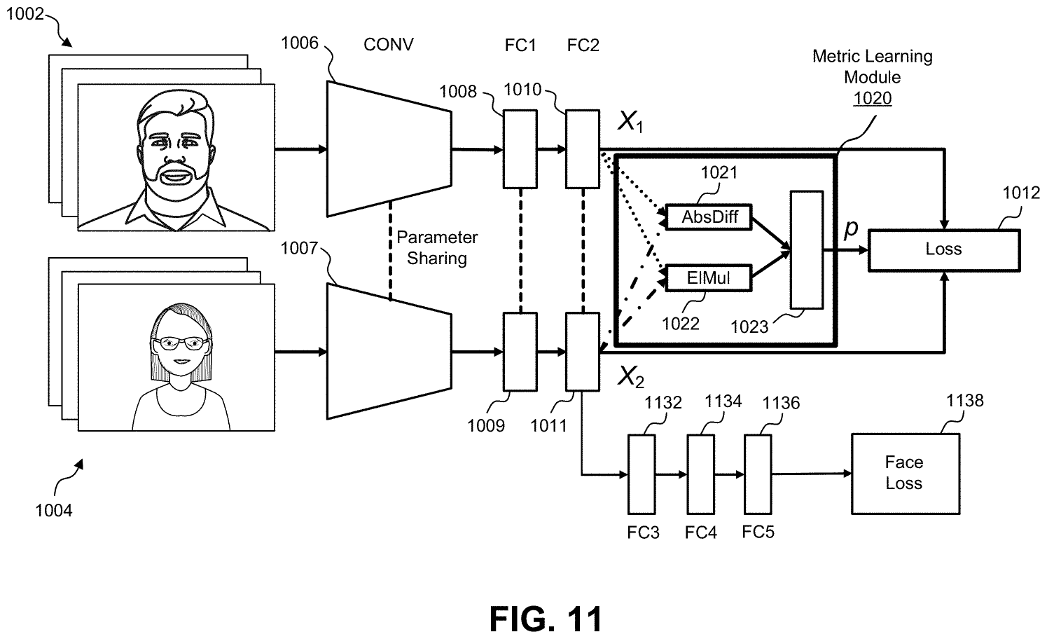

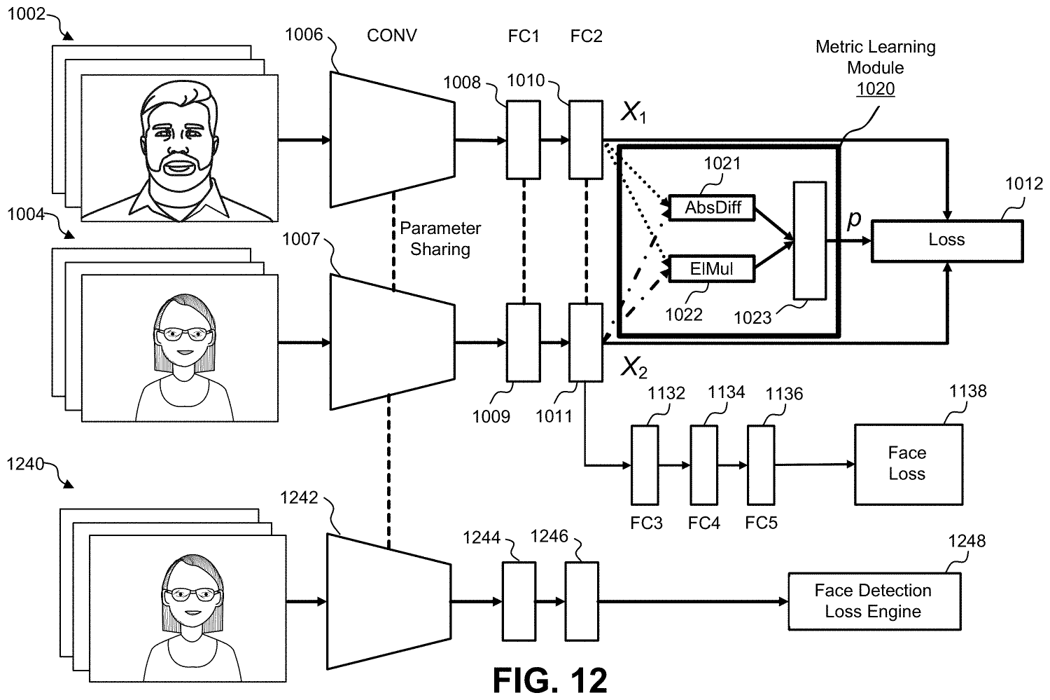

FIG. 10, FIG. 11, and FIG. 12 are diagrams illustrating different examples of neural network architectures that can be used for the face change detector 540 of FIG. 5. The diagrams in FIG. 10 and FIG. 11 illustrate the neural network during training, where one or more loss functions are used to determine which neural network parameters to adjust based on a backpropagation process. In some cases, the neural network includes a deep neural network and/or other type of neural network. For illustrative purposes, a Siamese (or twin) training strategy is used, where the neural network uses the same weights while working in tandem on two different input vectors (input images 1002 and input images 1004) to compute comparable output vectors. Other training techniques can be used in some cases. A backpropagation engine can be used during training of the face change detection neural network and can perform the backpropagation process to tune parameters (e.g., weights, biases, etc.) of the neural network based on the one or more loss functions. In some cases, the backpropagation process can be based on stochastic gradient descent techniques. Backpropagation can include a forward pass, one or more loss functions, a backward pass, and a parameter update (e.g., to update certain weights and/or other parameter(s)). The forward pass, loss function, backward pass, and parameter update are performed for one training iteration. The process can be repeated for a certain number of iterations for each set of training data until the weights and/or other parameters of the neural network are accurately tuned.

For example, as shown in FIG. 10, one or more input images 1002 and one or more input images 1004 are used as a training dataset to train the neural network of the face change detector. The input images 1002 and the input images 1004 can be provided as input to the neural network individually (one image from the images 1002 and one image from the images 1004 are input at each training iteration) or in batches (including multiple images from the images 1002 and multiple images from the images 1004 at each training iteration). The input images can be referred to as the input layer of the neural network. A goal of the training is to train the neural network of the face change detector to determine when two images contain the same face (and thus cause the device to be maintained in an unlocked state) and also to determine when two images contain different faces (and thus cause the device to be locked).

The neural network includes various hidden layers that are used to process the input images 1002 and 1004. The architecture of the neural network is set up with a short-term memory, where the face change detector only needs to be able to recognize a user of particular session (as described above). A first hidden layer of the neural network includes convolutional layers, including a convolution layer 1006 and a convolutional layer 1007. The convolutional layers can be considered as one or more filters (each filter corresponding to a different activation or feature map), with each convolutional iteration of a filter being a node of the convolutional layer. The region of the input image that a filter covers at each convolutional iteration is referred be the receptive field for the filter. In one illustrative example, if the input image includes a 28×28 array, and each filter (and corresponding receptive field) is a 5×5 array, then there will be 24×24 nodes in the convolutional layer. Each connection between a node and a receptive field for that node learns a weight and, in some cases, an overall bias such that each node learns to analyze its particular local receptive field in the input image. Each node of the convolutional layer will have the same weights and bias (called a shared weight and a shared bias). For example, a convolutional filter can have an array of weights (numbers) and the same depth as the input. A filter will can have a depth of 3 when an image is input to the neural network (according to three color components of the input image). An illustrative example size of the filter array is 5×5×3, corresponding to a size of the receptive field of a node.

The convolutional nature of the convolutional layer is due to each node of the convolutional layer being applied to its corresponding receptive field. For example, a filter of the convolutional layer 1006 can begin in the top-left corner of the array of the input image and can convolve around the input image. As noted above, each convolutional iteration of the filter can be considered a node or neuron of the convolutional layer. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional layer. For example, a filter can be moved by a step amount (referred to as a stride) to the next receptive field. The stride can be set to 1 or other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional layer.

The mapping from one layer (e.g., the input layer) to another layer (e.g., a convolutional layer) in the network is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional layer can include several activation maps in order to identify multiple features in an image. Each activation map can detect a different feature from the image, with each feature being detectable across the entire image.

In some examples, a non-linear layer (not shown) can be applied after the convolutional layers 1006 and 1007. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the neural network without affecting the receptive fields of the convolutional layers.

In some cases, a pooling layer can be applied after the convolutional layer (and/or after the non-linear hidden layer when used). A pooling layer is used to simplify the information in the output from the convolutional layers 1006 and 1007. For example, the pooling layer can take each activation map output from the convolutional layer and generates a condensed activation map (or feature map) using a pooling function. Max-pooling is one example of a function performed by a pooling hidden layer. Other forms of pooling functions be used by the pooling layer, such as average pooling, L2-norm pooling, or other suitable pooling functions. A pooling function (e.g., a max-pooling filter, an L2-norm filter, or other suitable pooling filter) is applied to each activation map included in the convolutional layer.

The convolutional layers 1006 and 1007 thus determine all the features of the faces in the image 1002 and 1004. While only a single level of convolutional layers 1006 and 1007 are shown, multiple convolutional layers can be provided to determine varying levels of features from the images. As shown in FIG. 10, the neural network also includes two fully-connected (FC) layers (FC1 and FC2) that can be used for the face change detection. The FC1 and FC2 layers are used to determine the classifications from the features provided by the convolutional layers 1006 and 1007. The FC1 layer includes FC channel 1008 and FC channel 1009, and the FC2 layer includes FC channel 1010 and FC channel 1011. The output of the FC channel 1010 is features Xi from one or more of the input images 1002 and the output of the FC channel 1011 is features X2 from one or more of the input images 1004. The features X₁, X₂ can be feature vectors in some cases. While two FC layers are used in the neural network shown in FIG. 10, a single FC layer or more than two FC layers can be used in some implementations.

The neural network also includes a metric learning module 1020. The metric learning module 1020 can be used to make sure that features are separable for different people depicted in different images and are not separable for the same person depicted in different images. The network then minimizes the cross-entropy loss for classification. For example, the metric learning module 1020 can perform an absolute difference function 1021 and an element-wise multiplication function 1022 on the features X₁ and X₂, resulting in the features X₁ and X₂ being concatenated or otherwise combined into a feature vector p. The absolute difference function 1021 determines the absolute value of the differences between the features X₁ and X₂. In some cases, the absolute difference can be represented as follows:

AbsDiff=|X₁−X₂|

The element-wise multiplication function 1022 is the element-wise multiplication of X₁ times X₂. For example, the element-wise multiplication function 1022 is a binary operation that can use the two feature vectors X₁ and X₂ with the same dimensions as input. Using the two feature vectors X₁ and X₂ with the same dimensions, the element-wise multiplication function 1022 can produce resulting feature vector p of the same dimension as the feature vectors X₁ and X₂. Each element i, j of the resulting feature vector p is generated by determining the product of each elements i, j of the original two feature vectors X₁ and X₂. For example, the first element in the feature vector X₁ is multiplied by the first element in the feature vector X₂. The resulting product can be used as the first element in the resulting feature vector p. The result of the absolute difference function 1021 and the element-wise multiplication function 1022 is concatenated by a concatenation layer 1023.

Concatenating the two feature vectors X₁ and X₂ into the resulting feature vector p allows the neural network to directly classify the loss 1012, increasing the accuracy of the face change detector. For example, the metric learning module 1020 can determine a cross-entropy classification loss based on the feature vector p resulting from the features X₁ from the one or more of the input images 1002 and the features X₂ from the one or more of the input images 1004. The cross-entropy loss function used for the loss 1012 can be expressed as follows:

$${E}_{M L} ( X , L ) = - log \frac{exp ( p [ L ] )}{{\sum }_{j} exp ( p [ j ] )} \qquad$$

where L is a ground truth label (e.g., a label of 1 or 0 as described above) and p is a predicted score or label. The cross-entropy loss trains the network to generate X₁ and X₂ so that the features are different for different faces and so that the features are similar or the same for the same faces. For example, once the feature vectors X₁ and X₂ are concatenated together into the feature vector p, the loss 1012 trains the neural network to determine whether the feature vector p is from one person or from two different people. In some cases, some or all concatenated feature vectors p for a same person depicted in two input images (e.g., images 1002 and 1004) are assigned a first label (e.g., a label of 1). In some cases, some or all concatenated feature vectorsp for different persons in two input images (e.g., images 1002 and 1004) are assigned a second label (e.g., a label of 0). The labels are used for supervised learning of the neural network. Minimizing the cross-entropy loss function maximizes the differences between the features generated when different people are in the input images as compared to the features generated when the same person is in the input images. Thus, by minimizing the cross-entropy loss, the network can learn how to separate the differentp vectors.

In order to further ensure that features X₁, X₂ generated for the same person in two input images are different than the features X₁, X₂ generated for two different people in two input images, the neural network can be trained using a center loss and a cosine embedding loss. In one illustrative example, the center loss can be expressed as follows:

E_{CL}(X)=Σᵢ₌₁²∥xᵢ−c_{y}_{ᵢ}∥₂²

The center loss attempts to separate the centers (e.g., Euclidean centers) of the two feature vectors X₁ and X₂ from the different input images. For example, if two feature vectors X₁ and X₂ from two input images are the same person, the centers are made the same or close together. If two feature vectors X₁ and X₂ from two input images are for different people, the centers are made as far apart as possible. Pushing the centers away from each other using the center loss ensures that there is no overlap between the two classes (the class for features generated for two different people versus the features generated for the same person), making it less probable that there will be a misclassification error.

In one illustrative example, the cosine embedding loss can be expressed as follows:

E_{cos}(X₁, X₂L)=(1−L)·max(0, cos(X₁, X₂)−m)+L·(1−cos(X₁, X₂))

where L is the ground truth label (as noted above), m is a margin, and c_{y} is the y^{th} class center. The cosine embedding loss is similar to the center loss, but is in the angular domain (where the center loss is in the Euclidean domain). For example, the cosine embedding loss attempts to ensure that the angular distance between two feature vectors X₁ and X₂ for the same person are small (e.g., 0° or close to 0°. The cosine embedding loss can also attempt to ensure that the angular distance between two feature vectors X₁ and X₂ for different people is large (e.g., 180° or close to 180°.

In some examples, as illustrated by the neural network architecture shown in FIG. 11, a face model loss (or face loss) can also be used. The face loss can be used to cause the neural network to focus on a face region of an image as opposed to regions outside of the face region (e.g., the background). In one illustrative example, the face loss can be expressed as follows:

$${E}_{F L} ( X ) = \frac{1}{\vert 𝔉 \vert} \cdot {\sum }_{m ∈ 𝔉} {‖ lgt ( m ) - {l}_{pred} ( m ) ‖}^{2} + \frac{1}{\vert V \vert} \cdot {\sum }_{m ∈ V} Cos Dist ( {vec}_{gt} ( m ) , {vec}_{pred} ( m ) ) + \frac{1}{\vert D \vert} \cdot {\sum }_{m ∈ D} {‖ distgt ( m ) - {dist}_{pred} ( m ) ‖}^{2}$$

where l refers to a facial landmark, vec refers to a vector defined between two facial landmarks, and dist refers to a distance between two facial landmarks. The face change detector 540 may not generate bounding boxes to localize the faces in images (which further decreases power consumption). Even when no bounding boxes are available, the face loss allows the neural network shown in FIG. 11 to learn to detect facial landmarks (e.g., landmarks on the eyes, eyebrows, nose, chin, among other face regions) in images. For example, the three additional fully connected (FC) layers (FC3 1132, FC4 1134, and FC5 1136) can be added to detect facial landmarks from the input images 1004, allowing the network to obtain high localization accuracy without using a bounding box prior. While the additional FC layers and a face loss 1138 are shown from the bottom portion of the neural network (from FC channel 1011), additional FC layers and an additional face loss can be added to the output of the FC channel 1010 in order to detect facial landmarks from the input images 1002.

Once trained using the various losses described above, the neural network will be able to assign a classification value of 1 to feature vectors that are generated for two images that include a same person (e.g., in which case the process 400 of FIG. 4 would determine that a same face is present at block 434) and will be able to apply a classification value of 0 to feature vectors that are generated for two images that include different people (e.g., in which case the process 400 of FIG. 4 would determine that a same face is not present at block 434). During inference (after the neural network is trained and is being used for actual face authentication), the neural network of the face change detector 540 can determine the distance (e.g., using a cosine distance or other distance metric) between the feature vector X₁ from a current input images and the feature vector X₂ of a previous input image. The neural network of the face change detector 540 can classify the features as being for the same person (label 1) or as being from a different person (label 0). For example, the face change detector 540 can determine a face change threshold is met when the label 1 is assigned and can determine a face change threshold is not met when the label 0 is assigned.

In some examples, as illustrated by the neural network architecture shown in FIG. 12, face detection network components can be included that allow face detection to be jointly estimated with the neural network of the face change detector 540. The face detection network components include a convolutional layer 1242, a fully connected layer 1244, a fully connected layer 1246, and a face detection loss 1248. Input images 1240 can be provided as input to the face detection network (e.g., one image from the images 1240 is input to the convolutional layer 1242 at each training iteration) or in batches (including multiple images from the images 1240 are input at each training iteration). In some cases, the convolutional layer 1242, the fully connected layer 1244, and the fully connected layer 1246 operate similarly as the convolutional layers and fully connected layers described with respect to FIG. 10 and FIG. 11. In some examples, the face detection loss 1248 can include a face detection SoftMax loss function used to train the face detection network components to effectively and accurately classify objects as faces. Any suitable dataset can be used to train the face detection network components to perform face classification. Using the neural network architecture shown in FIG. 12, the face change detector 540 can jointly (using a common neural network architecture) perform face classification (or detection) and face change detection.

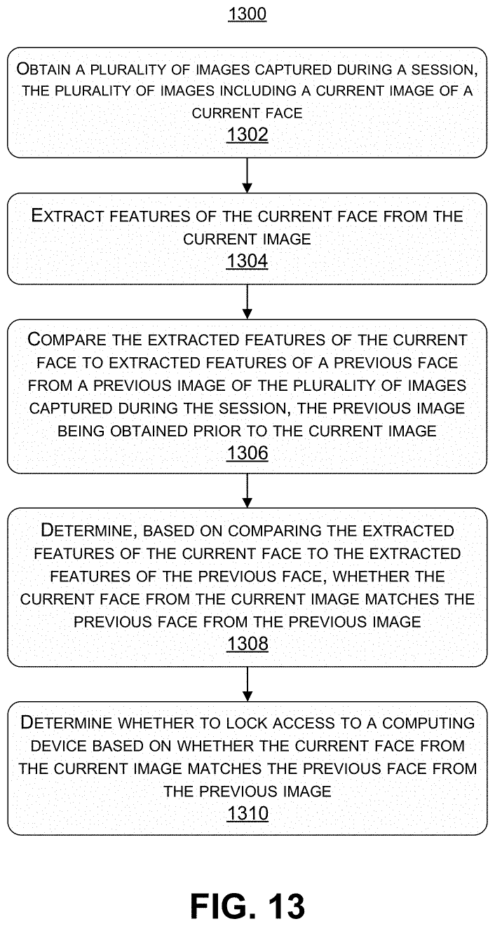

FIG. 13 is a flowchart illustrating an example of a process 1300 of processing one or more images using the techniques described herein. At block 1302, the process 1300 includes obtaining a plurality of images captured during a session. The plurality of images include a current image of a current face. In some examples, the session (also referred to as a current session) includes a period of time between a first time when access to the computing device was last unlocked and a second time when access to the computing device is locked after the first time. For instance, the session can include the period of time starting from when access to the computing device was last unlocked to a next time at which access to the computing device is locked (e.g., at block 427 of FIG. 4). In some examples, the session can include a period of time starting from when the screen of the computing device was last turned off (e.g., at block 425 of FIG. 4) to the time when access to the computing device is locked (e.g., at block 427).

At block 1304, the process 1300 includes extracting features of the current face from the current image. Any suitable feature extraction technique can be used. For instance, once trained, one or more of the neural network architectures (of the face change detector 540) illustrated in FIG. 10-FIG. 12 can be used to extract features from the current image. In some cases, a feature extraction process similar to that described above with respect to block 204 of FIG. 2 can be performed.

At block 1306, the process 1300 includes comparing the extracted features of the current face to extracted features of a previous face. For instance, once trained, one or more of the neural network architectures (of the face change detector 540) illustrated in FIG. 10-FIG. 12 can compare the extracted features of the current face to extracted features of the previous face. The previous face is from a previous image of the plurality of images captured during the session. The previous image is obtained prior to the current image. In some examples, the previous face is a previously-detected face from the previous image. For instance, the previous image that is compared to the current image can include the image in which a face was last detected. In some examples, the previous face is a previously-authenticated face from the previous image. For instance, the previous image that is compared to the current image can include the image for which the user's face was authenticated (e.g., at block 428 of FIG. 4) to unlock the device.

At block 1308, the process 1300 includes determining, based on comparing the extracted features of the current face to the extracted features of the previous face, whether the current face from the current image matches the previous face from the previous image. In some cases, one or more of the neural network architectures (of the face change detector 540) illustrated in FIG. 10-FIG. 12 can provide an output indicating whether the current face from the current image matches the previous face from the previous image. For example, once trained using one or more of the losses described above, one or more of the neural networks shown in FIG. 10-FIG. 12 can output a classification value of 1 when the current face and the previous face are of a same person (e.g., in which case the process 400 of FIG. 4 would determine that a same face is present at block 434). The one or more neural networks of the face change detector 540 can output a classification value of 0 when the current face and the previous face are of different people (e.g., in which case the process 400 of FIG. 4 would determine that a same face is not present at block 434). In one illustrative example, when used during inference (after training), the one or more neural networks of the face change detector 540 can determine the distance (e.g., a cosine distance or other distance metric) between the feature vector X₁ from the current images and the feature vector X₂ of the previous image. The one or more neural networks of the face change detector 540 can classify the features as being for the same person (label 1) or as being from a different person (label 0). In such an example, the face change detector 540 can determine a face change threshold is met when the label 1 is assigned and can determine a face change threshold is not met when the label 0 is assigned.

In some examples, the one or more neural networks can jointly detect the current face in the current image based on the extracted features and determine whether the current face from the current image matches the previous face from the previous image. For instance, once trained, the neural network architecture shown in FIG. 12 can be used to jointly perform face detection and face change detection.

At block 1310, the process 1300 includes determining whether to lock access to a computing device based on whether the current face from the current image matches the previous face from the previous image. In one example, the process 1300 includes determining, based on comparing the extracted features of the current face to the extracted features of the previous face, that the current face from the current image matches the previous face from the previous image. In such an example, the process 1300 can include maintaining the computing device in an unlocked state based on the current face from the current image matching the previous face from the previous image. In another example, the process 1300 includes determining, based on comparing the extracted features of the current face to the extracted features of the previous face, that the current face from the current image is different than the previous face from the previous image. In such an example, the process 1300 can include locking access to the computing device based on the current face from the current image being different than the previous face from the previous image.

In some examples, the process 1300 can perform the smart wake-up feature described above. For example, in some cases, the process 1300 includes obtaining an additional image and determining a face in the additional image matches a face in at least one previous image (where the face in the at least one previous image is determined to be an authenticated face). The process 1300 can include unlocking access to the computing device based on determining the face in the additional image matches the face in the at least one previous image.

In some examples, the process 1300 can determine not to wake up an authentication engine when the face change detection results in detecting a same face that was previously determined not to be an authenticated face. For example, in some cases, the process 1300 includes obtaining an additional image and determining a face in the additional image matches a face in at least one previous image (where the face in the at least one previous image is previously rejected as an unauthenticated face). The process 1300 can include determining not to wake up the authentication engine based on determining the face in the additional image matches the face in the at least one previous image.

In some examples, the process 1300 includes receiving user credentials associated with the computing device. The process 1300 can include unlocking access to the computing device based on the user credentials. In some examples, the user credentials include a face identification (ID) of a user authorized to access the computing device. In some cases, access to the computing device is unlocked before performing the operation of block 1302.

In some examples, a display of the computing device is on. In such examples, the process 1300 can include determining a first predetermined time period has elapsed since detection of one or more actions with the computing device (e.g., as shown in block 422 of

FIG. 4). Illustrative examples of activity can include a user interacting with the device, opening and/or closing of applications on the device, typing using the device, detected movement of the device (e.g., as measured by one or more sensors, such as one or more IMUs, accelerometers, gyroscopes, etc.), motion detected relative to the device (e.g., as measured by an optical motion sensor or other sensor), sound or audio commands detected by the device (e.g., detected using a voice recognition algorithm), and/or other activity or action.

The process 1300 can include causing the display of the computing device to turn off based on determining the first predetermined time period has elapsed (e.g., as shown in blocks 424 and 425 of FIG. 4). In some examples, the process 1300 includes determining, based on comparing the extracted features of the current face to the extracted features of the previous face, that the current face from the current image matches the previous face from the previous image (e.g., at block 434 of FIG. 4). The process 1300 can include causing the display of the computing device to turn on based on the current face from the current image matching the previous face from the previous image (e.g., at block 421 of FIG. 4).

In some examples, the process 1300 includes determining a second predetermined time period has not elapsed (e.g., at block 426 of FIG. 4) since at least one of detection of one or more actions with the computing device or detection of one or more faces in one or more images. In the event the process 1300 determines that the second predetermined time period has not elapsed, the process 1300 can include extracting the features of the current face from the current image and comparing the extracted features of the current face to the extracted features of the previous face (e.g., at blocks 432 and/or 434 of FIG. 4). In the event the process 1300 determines that the second predetermined time period has elapsed, the process 1300 can include locking access to the computing device (e.g., at block 427 of FIG. 4). In some cases, a display of the computing device is off when determining the second predetermined time period has elapsed.

In some examples, the processes described herein (e.g., process 400, 1300, and/or other process described herein) may be performed by a computing device or apparatus. In one example, the process 1300 can be performed by a computing device (e.g., mobile device 102 in FIG. 1) having a computing architecture of the computing system 1400 shown in FIG. 14. The computing device can also include the face change detector 540 shown in FIG. 5, which can implement a neural network trained using the process described above with respect to FIG. 10-FIG. 12.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 1300. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes 400 and 1300 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The processes 400, 1300, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 is a diagram illustrating an example of a system for implementing certain aspects of the present technology. In particular, FIG. 14 illustrates an example of computing system 1400, which can be for example any computing device making up internal computing system, a remote computing system, a camera, or any component thereof in which the components of the system are in communication with each other using connection 1405.

Connection 1405 can be a physical connection using a bus, or a direct connection into processor 1410, such as in a chipset architecture. Connection 1405 can also be a virtual connection, networked connection, or logical connection.

In some embodiments, computing system 1400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1400 includes at least one processing unit (CPU or processor) 1410 and connection 1405 that couples various system components including system memory 1415, such as read-only memory (ROM) 1420 and random access memory (RAM) 1425 to processor 1410. Computing system 1400 can include a cache 1412 of high-speed memory connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400. Computing system 1400 can include communications interface 1440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some embodiments, a hardware service that performs a particular function can include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method of processing one or more images, the method comprising:
obtaining a plurality of images captured during a session, the plurality of images including a current image of a current face;
extracting features of the current face from the current image;
comparing the extracted features of the current face to extracted features of a previous face from a previous image of the plurality of images captured during the session, the previous image being obtained prior to the current image;
determining, based on comparing the extracted features of the current face to the extracted features of the previous face, whether the current face from the current image matches the previous face from the previous image; and
determining whether to lock access to a computing device based on whether the current face from the current image matches the previous face from the previous image.

2. The method of claim 1, wherein the session includes a period of time between a first time when access to the computing device was last unlocked and a second time when access to the computing device is locked after the first time.

3. The method of claim 1, further comprising:
determining, based on comparing the extracted features of the current face to the extracted features of the previous face, that the current face from the current image matches the previous face from the previous image; and
maintaining the computing device in an unlocked state based on the current face from the current image matching the previous face from the previous image.

4. The method of claim 1, further comprising:
determining, based on comparing the extracted features of the current face to the extracted features of the previous face, that the current face from the current image is different than the previous face from the previous image; and
locking access to the computing device based on the current face from the current image being different than the previous face from the previous image.

5. The method of claim 4, further comprising:
obtaining an additional image;
determining a face in the additional image matches a face in at least one previous image, the face in the at least one previous image being an authenticated face; and
unlocking access to the computing device based on determining the face in the additional image matches the face in the at least one previous image.

6. The method of claim 4, further comprising:
obtaining an additional image;
determining a face in the additional image matches a face in at least one previous image, the face in the at least one previous image being rejected as an unauthenticated face; and
determining not to wake up an authentication engine based on determining the face in the additional image matches the face in the at least one previous image.

7. The method of claim 4, further comprising:
receiving user credentials associated with the computing device; and
unlocking access to the computing device based on the user credentials.

8. The method of claim 7, wherein the user credentials include a face identification (ID) of a user authorized to access the computing device.

9. The method of claim 1, wherein a display of the computing device is on, the method comprising:
determining a first predetermined time period has elapsed since detection of one or more actions with the computing device; and
causing the display of the computing device to turn off based on determining the first predetermined time period has elapsed.

10. The method of claim 9, further comprising:
determining, based on comparing the extracted features of the current face to the extracted features of the previous face, that the current face from the current image matches the previous face from the previous image; and
causing the display of the computing device to turn on based on the current face from the current image matching the previous face from the previous image.

11. The method of claim 9, further comprising:
determining a second predetermined time period has not elapsed since at least one of detection of one or more actions with the computing device or detection of one or more faces in one or more images; and
based on determining the second predetermined time period has not elapsed, extracting the features of the current face from the current image and comparing the extracted features of the current face to the extracted features of the previous face.

12. The method of claim 9, further comprising:
determining a second predetermined time period has elapsed since at least one of detection of one or more actions with the computing device or detection of one or more faces in one or more images; and
locking access to the computing device based on determining the second predetermined time period has elapsed.

13. The method of claim 12, wherein a display of the computing device is off when determining the second predetermined time period has elapsed.

14. The method of claim 1, wherein the previous face is a previously-detected face from the previous image.

15. The method of claim 1, wherein the previous face is a previously-authenticated face from the previous image.

16. The method of claim 1, further comprising:
processing the current image using a neural network, the neural network jointly detecting the current face in the current image based on the extracted features and determining whether the current face from the current image matches the previous face from the previous image.

17. An apparatus for processing one or more images, comprising:
a memory configured to store the one or more images; and
at least one processor coupled to the memory and configured to:
obtain a plurality of images captured during a session, the plurality of images including a current image of a current face;
extract features of the current face from the current image;
compare the extracted features of the current face to extracted features of a previous face from a previous image of the plurality of images captured during the session, the previous image being obtained prior to the current image;
determine, based on comparing the extracted features of the current face to the extracted features of the previous face, whether the current face from the current image matches the previous face from the previous image; and
determine whether to lock access to a computing device based on whether the current face from the current image matches the previous face from the previous image.

18. The apparatus of claim 17, wherein the session includes a period of time between a first time when access to the computing device was last unlocked and a second time when access to the computing device is locked after the first time.

19. The apparatus of claim 17, wherein the at least one processor is configured to:
determine, based on comparing the extracted features of the current face to the extracted features of the previous face, that the current face from the current image matches the previous face from the previous image; and
maintain the computing device in an unlocked state based on the current face from the current image matching the previous face from the previous image.

20. The apparatus of claim 17, wherein the at least one processor is configured to:
determine, based on comparing the extracted features of the current face to the extracted features of the previous face, that the current face from the current image is different than the previous face from the previous image; and
lock access to the computing device based on the current face from the current image being different than the previous face from the previous image.

21. The apparatus of claim 20, wherein the at least one processor is configured to:
obtain an additional image;
determine a face in the additional image matches a face in at least one previous image, the face in the at least one previous image being an authenticated face; and
unlock access to the computing device based on determining the face in the additional image matches the face in the at least one previous image.

22. The apparatus of claim 20, wherein the at least one processor is configured to:
obtain an additional image;
determine a face in the additional image matches a face in at least one previous image, the face in the at least one previous image being rejected as an unauthenticated face; and
determine not to wake up an authentication engine based on determining the face in the additional image matches the face in the at least one previous image.

23. The apparatus of claim 17, wherein a display of the computing device is on, wherein the at least one processor is configured to:
determine a first predetermined time period has elapsed since detection of one or more actions with the computing device; and
cause the display of the computing device to turn off based on determining the first predetermined time period has elapsed.

24. The apparatus of claim 23, wherein the at least one processor is configured to:
determine, based on comparing the extracted features of the current face to the extracted features of the previous face, that the current face from the current image matches the previous face from the previous image; and
cause the display of the computing device to turn on based on the current face from the current image matching the previous face from the previous image.

25. The apparatus of claim 23, wherein the at least one processor is configured to:
determine a second predetermined time period has not elapsed since at least one of detection of one or more actions with the computing device or detection of one or more faces in one or more images; and
based on determining the second predetermined time period has not elapsed, extract the features of the current face from the current image and comparing the extracted features of the current face to the extracted features of the previous face.

26. The apparatus of claim 23, wherein the at least one processor is configured to:
determine a second predetermined time period has elapsed since at least one of detection of one or more actions with the computing device or detection of one or more faces in one or more images; and
lock access to the computing device based on determining the second predetermined time period has elapsed.

27. The apparatus of claim 26, wherein a display of the computing device is off when determining the second predetermined time period has elapsed.

28. The apparatus of claim 17, wherein the previous face is at least one of a previously-detected face from the previous image or a previously-authenticated face from the previous image.

29. The apparatus of claim 17, wherein the at least one processor is configured to:
process the current image using a neural network, the neural network jointly detecting the current face in the current image based on the extracted features and determining whether the current face from the current image matches the previous face from the previous image.

30. The apparatus of claim 17, wherein the apparatus is a mobile device including a display configured to display at least one image.
